(19) United States
(12) Patent Application Publication
(10) Pub. No.: US 2013/0096892 A1
(43) Pub. Date: Apr. 18, 2013

(54) SYSTEMS AND METHODS FOR MONITORING AND PREDICTING USER PERFORMANCE

(71) Applicants: Alfred H. Essa, Cambridge (CA); Hanan G. A. Ayad, Waterloo (CA)

(72) Inventors: Alfred H. Essa, Cambridge (CA); Hanan G. A. Ayad, Waterloo (CA)

(21) Appl. No.: 13/652,765

(22) Filed: Oct. 16, 2012

Related U.S. Application Data
(60) Provisional application No. 61/669,190, filed on Jul. 9, 2012.
(60) Provisional application No. 61/548,135, filed on Oct. 17, 2011.

(51) Int. Cl. G06F 17/18

(52) U.S. Cl. CPC G06F 17/18
USPC 703/2

(57) ABSTRACT

The embodiments described herein relate performance prediction systems and methods. According to some aspects there is provided a performance prediction system comprising at least one processor, the at least one processor being configured to: define a predictive model based upon a plurality of hypothesises for predicting learner performance, each hypothesis predicting learner performance based upon at least one learner engagement activity; monitor a plurality of the learner engagement activities associated with the user identifier for that user to obtain learner engagement values for each of the learner engagement activities; generate at least one performance prediction value for each hypothesis based upon the learner engagement values associated with the hypothesis; and combine the performance prediction values for the plurality of the hypothesises to generate a combined performance prediction value for that learner.

### RELATED APPLICATIONS

This application claims the benefit of U.S. Provisional Patent Application Nos. 61/548,135 and 61/661,190 filed Oct. 17, 2011 and Jul. 9, 2012, respectively, the entire contents of which are hereby incorporated by reference herein for all purposes.

### TECHNICAL FIELD

The embodiments herein relate to electronic learning (“eLearning”) systems, and in particular to monitoring activities of one or more learners in a course in the eLearning system and predicting performance of the same.

### BACKGROUND

Electronic learning (also called e-Learning or eLearning) generally refers to education or learning where users (e.g. learners, instructors, administrative staff) engage in education related activities using computers and other computing devices. For examples, learners may enroll or participate in a course or program of study offered by an educational institution (e.g. a college, university or grade school) through a web interface that is accessible over the Internet. Similarly, learners may receive assignments electronically, participate in group work and projects by collaborating online, and be graded based on assignments and examinations that are submitted using an electronic dropbox.

Electronic learning is not limited to use by educational institutions, however, and may also be used in governments or in corporate environments. For example, employees at a regional branch office of a particular company may use electronic learning to participate in a training course offered by their company's head office without ever physically leaving the branch office.

Electronic learning can also be an individual activity with no institution driving the learning. For example, individuals may participate in self-directed study (e.g. studying an electronic textbook or watching a recorded or live webcast of a lecture) that is not associated with a particular institution or organization.

Electronic learning often occurs without any face-to-face interaction between the users in the educational community. Accordingly, electronic learning overcomes some of the geographic limitations associated with more traditional learning methods, and may eliminate or greatly reduce travel and relocation requirements imposed on users of educational services.

Furthermore, because course materials can be offered and consumed electronically, there are fewer physical restrictions on learning. For example, the number of learners that can be enrolled in a particular course may be practically limitless, as there may be no requirement for physical facilities to house the learners during lectures. Furthermore, learning materials (e.g. handouts, textbooks, etc.) may be provided in electronic formats so that they can be reproduced for a virtually unlimited number of learners. Finally, lectures may be recorded and accessed at varying times (e.g. at different times that are convenient for different users), thus accommodating users with varying schedules, and allowing users to be enrolled in multiple courses that might have a scheduling conflict when offered using traditional techniques.

Despite the effectiveness of electronic learning systems, some learners of an electronic learning system are unable to perform as well as their peers. For instance, the learners in the electronic learning systems (in contrast to traditional “brick and motor” learning) do not regularly attend physical classrooms for in-person interactions with other learners or their instructors. As such, it may be difficult for an instructor to determine how engaged the learners are and to identify which learners are at-risk of not succeeding in the course. Furthermore, even if the instructors are aware that some learners are at-risk, it may be difficult for the instructor to diagnose why these learners are at-risk to determine the appropriate corrective action, as the instructors usually do not regularly interact with these learners in person.

### SUMMARY

According to some aspects, there is provided a performance prediction system comprising at least one processor, the at least one processor being configured to: define a predictive model based upon a plurality of hypothesises for predicting learner performance, each hypothesis predicting learner performance based upon at least one learner engagement activity; monitor a plurality of the learner engagement activities associated with the user identifier for that user to obtain learner engagement values for each of the learner engagement activities; generate at least one performance prediction value for each hypothesis based upon the learner engagement values associated with the hypothesis; and combine the performance prediction values for the plurality of the hypothesises to generate a combined performance prediction value for that learner.

According to some aspects, there is provided a computer-implemented method for predicting performance of at least one learner. For each learner having a user identifier associated therewith, the method includes: defining a predictive model based upon a plurality of hypothesises for predicting learner performance, each hypothesis predicting learner performance based upon at least one learner engagement activity; monitoring a plurality of the learner engagement activities associated with the user identifier for that user to obtain learner engagement values for each of the learner engagement activities; generating at least one performance prediction value for each hypothesis based upon the learner engagement values associated with the hypothesis; and combining the performance prediction values for the plurality of the hypothesises to generate a combined performance prediction value for the learner.

### BRIEF DESCRIPTION OF THE DRAWINGS

Various embodiments will now be described, by way of example only, with reference to the following drawings, in which:

FIG. 1 is a schematic diagram of an electronic learning system for monitoring and predicting user performance according to some embodiments;

FIG. 2 is a schematic diagram illustrating various modules provided by the system in FIG. 1;

FIG. 3 is a table illustrating exemplary activities and course resources that can be monitored by the monitoring module shown in FIG. 2;

FIG. 4 is a schematic diagram illustrating exemplary data received by the performance prediction module shown in FIG. 2;

FIG. 5 is a schematic diagram illustrating a first exemplary visual display generated by the visualization module shown in FIG. 2;

FIG. 6 is a schematic diagram illustrating a second exemplary visual display generated by the visualization module shown in FIG. 2;

FIG. 7 is a schematic diagram illustrating a third exemplary visual display generated by the visualization module shown in FIG. 2;

FIG. 8 is a schematic diagram illustrating a fourth exemplary visual display generated by the visualization module shown in FIG. 2;

FIG. 9 is a schematic diagram illustrating a fifth exemplary visual display generated by the visualization module shown in FIG. 2;

FIG. 10 is a schematic diagram illustrating a sixth exemplary visual display generated by the visualization module shown in FIG. 2;

FIG. 11 is a schematic diagram illustrating IT infrastructures that may be used to implement a student success system according to some other embodiments;

FIG. 12 is a flow chart illustrating steps of a method for predicting performance of at least one learner according to some other embodiments;

FIG. 13 is a schematic diagram showing how a user may develop diagnostic insights and design personalized corrective actions according to some embodiments;

FIG. 14 is a schematic diagram illustrating a system for providing a learning environment according to some embodiments;

FIG. 15 is a schematic diagram illustrating an exemplary system architecture for implementing a student success system (“S3”) application according to some embodiments;

FIG. 16 is a schematic diagram illustrating an exemplary database schema that may be implemented to store data related to the student success system shown in FIG. 15;

FIG. 17 is a schematic diagram illustrating an exemplary visualization that may be provided by various systems according to some embodiments;

FIG. 18 is a schematic diagram illustrating an exemplary visualization that may be provided by various systems according to some embodiments;

FIG. 19 is a schematic diagram illustrating an exemplary visualization that may be provided by various systems according to some embodiments; and

FIG. 20 is a schematic diagram illustrating an exemplary visualization that may be provided by various systems according to some embodiments.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

In some embodiments, it is desirable to identify at-risk learners so that corrective action, if necessary, could be applied to those learners to improve their likelihood of success. It may also be desirable to identify such at-risk learners at earlier stages of one or more courses as this would provide those learners more time to improve their likelihood of success in courses where they are at-risk.

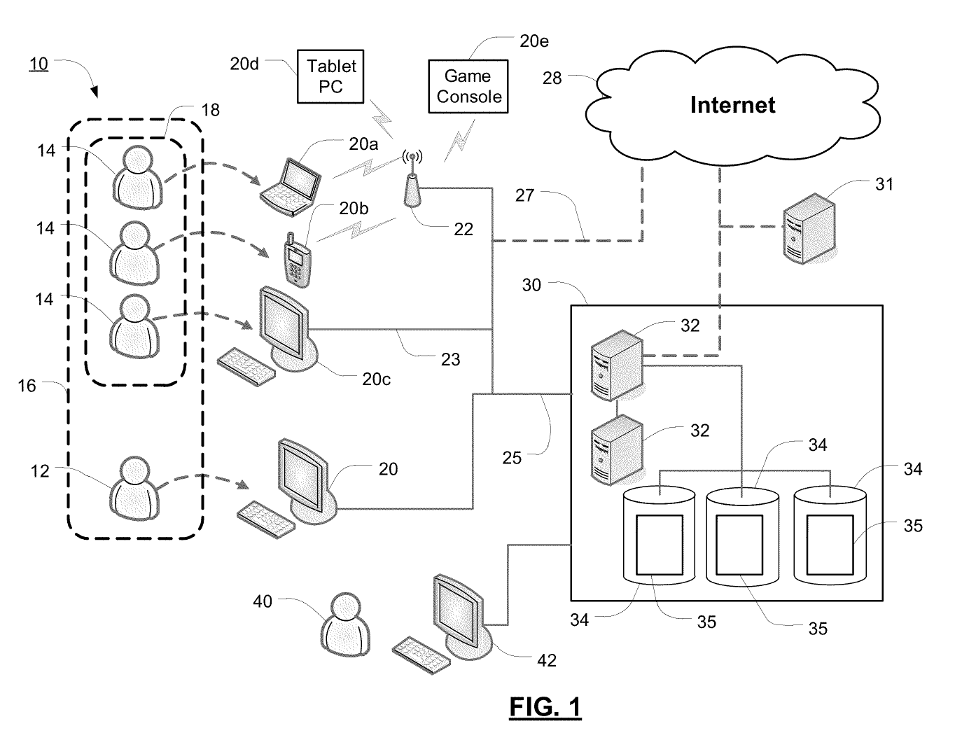

Referring now to FIG. 1, illustrated therein is a system 10 for monitoring and predicting user performance according to some embodiments. The system 10 as shown is an electronic learning system or eLearning system. However, in other instances the system 10 may not be limited to electronic learning systems and it may be other types of systems.

Using the system 10, one or more users 12, 14 may communicate with an educational service provider 30 to participate in, create, and consume electronic learning services, including educational courses. In some cases, the educational service provider 30 may be part of (or associated with) a traditional “bricks and mortar” educational institution (e.g. a grade school, university or college), another entity that provides educational services (e.g. an online university, a company that specializes in offering training courses, an organization that has a training department, etc.), or may be an independent service provider (e.g. for providing individual electronic learning).

It should be understood that a course is not limited to courses offered by formal educational institutions. The course may include any form of learning instruction offered by an entity of any type. For example, the course may be a training seminar at a company for a group of employees or a professional certification program (e.g. PMP, CMA, etc.) with a number of intended participants.

In some embodiments, one or more educational groups can be defined that includes one or more of the users 12, 14. For example, as shown in FIG. 1, the users 12, 14 may be grouped together in an educational group 16 representative of a particular course (e.g. History 101, French 254), with a first user 12 or “instructor” being responsible for organizing and/or teaching the course (e.g. developing lectures, preparing assignments, creating educational content etc.), while the other users 14 or “learners” are consumers of the course content (e.g. users 14 are enrolled in the course).

In some examples, the users 12, 14 may be associated with more than one educational group (e.g. the users 14 may be enrolled in more than one course, a user may be enrolled in one course and be responsible for teaching another course, a user may be responsible for teaching a plurality of courses, and so on).

In some cases, educational sub-groups may also be formed. For example, the users 14 are shown as part of educational sub-group 18. The sub-group 18 may be formed in relation to a particular project or assignment (e.g. sub-group 18 may be a lab group) or based on other criteria. In some embodiments, due to the nature of the electronic learning, the users 14 in a particular sub-group 18 need not physically meet, but may collaborate together using various tools provided by the educational service provider 30.

In some embodiments, other groups 16 and sub-groups 18 could include users 14 that share common interests (e.g. interests in a particular sport), that participate in common activities (e.g. users that are members of a choir or a club), and/or have similar attributes (e.g. users that are male, users under twenty-one years of age, etc.).

Communication between the users 12, 14 and the educational service provider 30 can occur either directly or indirectly using any one or more suitable computing devices. For example, the user 12 may use a computing device 20 having one or more client processors such as a desktop computer that has at least one input device (e.g. a keyboard and a mouse) and at least one output device (e.g. a display screen and speakers).

The computing device 20 can generally be any suitable device for facilitating communication between the users 12, 14 and the educational service provider 30. For example, the computing device 20 could be a laptop 20a wirelessly coupled to an access point 22 (e.g. a wireless router, a cellular communications tower, etc.), a wirelessly enabled personal data assistant (PDA) 20b or smart phone, a terminal 20c, a tablet computer 20d, or a game console 20e operating over a wired connection 23.

The computing devices 20 may be connected to the service provider 30 via any suitable communications channel. For example, the computing devices 20 may communicate to the educational service provider 30 over a local area network (LAN) or intranet, or using an external network (e.g. by using a browser on the computing device 20 to browse to one or more web pages or other electronic files presented over the Internet 28 over a data connection 27).

In some examples, one or more of the users 12, 14 may be required to authenticate their identities in order to communicate with the educational service provider 30. For example, each of the users 12, 14 may be required to input a user identifier such as a login name, and/or a password associated with that user or otherwise identify themselves to gain access to the system 10.

In some examples, one or more users (e.g. “guest” users) may be able to access the system without authentication. Such guest users may be provided with limited access, such as the ability to review one or more components of the course to decide whether they would like to participate in the course but without the ability to post comments or upload electronic files.

In some embodiments, the wireless access points 22 may connect to the educational service provider 30 through a data connection 25 established over the LAN or intranet. Alternatively, the wireless access points 22 may be in communication with the educational service provider 30 via the Internet 28 or another external data communications network. For example, one user 14 may use a laptop 20a to browse to a webpage that displays elements of an electronic learning system (e.g. a course page).

The educational service provider 30 generally includes a number of functional components for facilitating the provision of electronic learning services. For example, the educational service provider 30 generally includes one or more processing devices such as servers 32, each having one or more processors. The processors on the servers 32 will be referred to generally as “remote processors” so as to distinguish from client processors found in computing devices (20, 20a-20e). The servers 32 are configured to send information (e.g. electronic files such as web pages) to be displayed on one or more computing devices 20 in association with the electronic learning system 10 (e.g. course information). In some embodiments, a server 32 may be a computing device 20 (e.g. a laptop or personal computer).

The educational service provider 30 also generally includes one or more data storage devices 34 (e.g. memory, etc.) that are in communication with the servers 32, and could include a relational database (such as a SQL database), or other suitable data storage devices. The data storage devices 34 are configured to host data 35 about the courses offered by the service provider (e.g. the course frameworks, educational materials to be consumed by the users 14, records of assessments done by users 14, etc.).

The data storage devices 34 may also store authorization criteria that define what actions may be taken by the users 12, 14. In some embodiments, the authorization criteria may include at least one security profile associated with at least one role. For example, one role could be defined for users who are primarily responsible for developing an educational course, teaching it, and assessing work product from other users for that course. Users with such a role may have a security profile that allows them to configure various components of the course, post assignments, add assessments, evaluate performances, and so on.

In some embodiments, some of the authorization criteria may be defined by specific users 40 who may or may not be part of the educational community 16. For example, administrator users 40 may be permitted to administer and/or define global configuration profiles for the system 10, define roles within the system 10, set security profiles associated with the roles, and assign the roles to particular users 12, 14 in the system 10. In some cases, the users 40 may use another computing device (e.g. a desktop computer 42) to accomplish these tasks.

The data storage devices 34 may also be configured to store other information, such as personal information about the users 12, 14 of the system 10, information about which courses the users 14 are enrolled in, roles to which the users 12, 14 are assigned, particular interests of the users 12, 14 and so on.

The servers 32 and data storage devices 34 may also provide other electronic learning management tools (e.g. allowing users to add and drop courses, communicate with other users using chat software, etc.), and/or may be in communication with one or more other vendors that provide the tools.

In some embodiments, the system 10 may also have one or more backup servers 31 that may duplicate some or all of the data 35 stored on the data storage devices 34. The backup servers 31 may be desirable for disaster recovery (e.g. to prevent undesired data loss in the event of an event such as a fire, flooding, or theft). In some embodiments, the backup servers 31 may be directly connected to the educational service provider 30 but located within the system 10 at a different physical location.

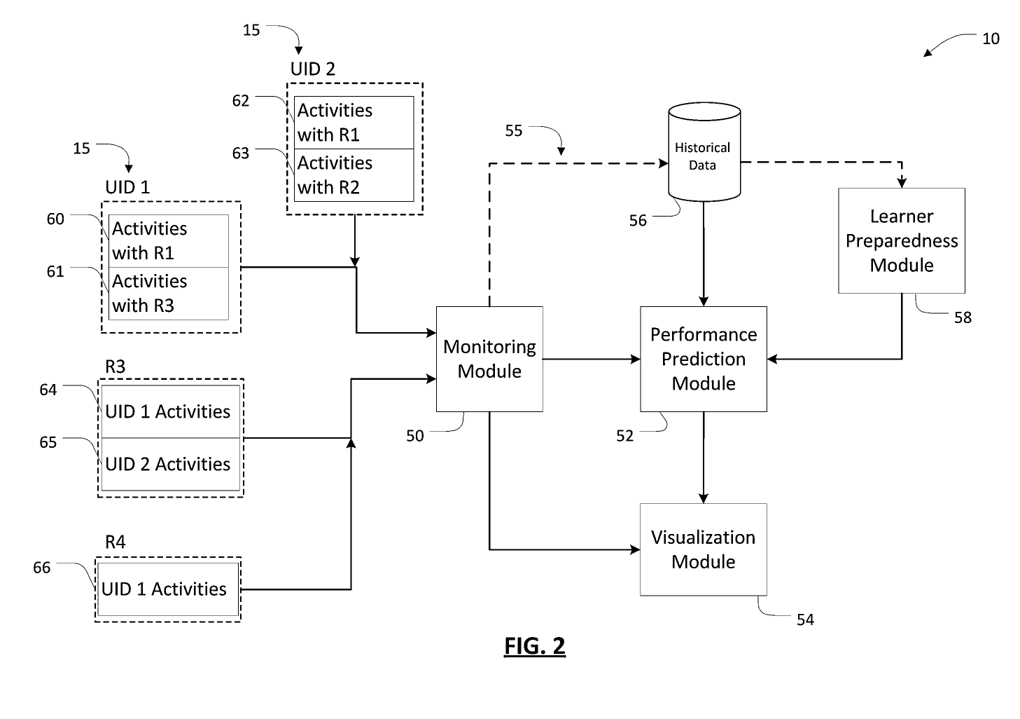

Referring now to FIG. 2, illustrated therein a schematic diagram of some modules that may be implemented by one or more processors of the system 10 according to some embodiments. In particular, one or more processors (not shown) may be configured to provide a performance prediction module 52 and/or other modules described herein below. In some embodiments, the processors may be the processors on the servers 32 shown in FIG. 1.

As shown, the system 10 includes a monitoring module 50, a performance prediction module 52, a visualization module 54 and a learner preparedness module 58. It should be understood that these modules are provided only to illustrate exemplary logical organization of how the one or more processors may be configured. In other embodiments, one or more of these modules may be combined with each other or with one or more other modules, or the processor(s) may be configured to provide one or more functionalities of the modules 50, 52, 54, and 58 without using any modules.

The monitoring module 50 is adapted to define a plurality of learner engagement activities 72 associated with a plurality of course resources for one or more learners in a course. This could be done on a learnerby learner basis, in bulk by course(s), or using a combination of both techniques.

In some cases, the learner engagement activities may be predefined. The learner engagement activities could also be defined based upon input from the instructor of a course. For example, the instructor may be prompted to select desired learner engagement activities from a plurality of available learner engagement activities.

These learner engagement activities are indicative of one or more hypothesises for predicting learner performance. For example, in a given course, learner engagement activities relating to attendance may be a very good predictor of learner performance. In other courses, learner engagement activities relating to social connectedness, participation, or completion of various tasks and so on might provide reliable predictors of learner performance.

The system 10 generally permits combination of various hypotheses in that it allows for the definition of a plurality of learner engagement activities, tracking of each activity (or each category of activity) individually and making predictions of performance value based on that data, then assembling the performance prediction values for each of the hypotheses to obtain a combined or ‘aggregate’ performance prediction value for a learner. This allows the instructors to give heed to various considerations by weighting the values at different levels of the calculation with a view towards improving the overall aggregate prediction value.

The defined learner engagement activities may vary from course to course. For example, some courses might emphasize social networking, while other courses may emphasis other types of learner engagement activities. Similarly, in some courses, preparedness of a learner may not be a factor in predicting the performance prediction value for that learner (e.g. if the course is an introductory course).

In some embodiments, the learner engagement activities may be defined to accommodate available historical data.

In some embodiments, if an organization has a strict course design structure, then some of the learner engagement activities might be predefined for all courses as the variance in design between courses in such an organization may be limited.

As shown, the defined learner engagement activities associated with the course resources include activities 60-66 associated with course R1, R2, R3 and R4. These course resources may be various types of resources provided by the system 10 to facilitate electronic learning.

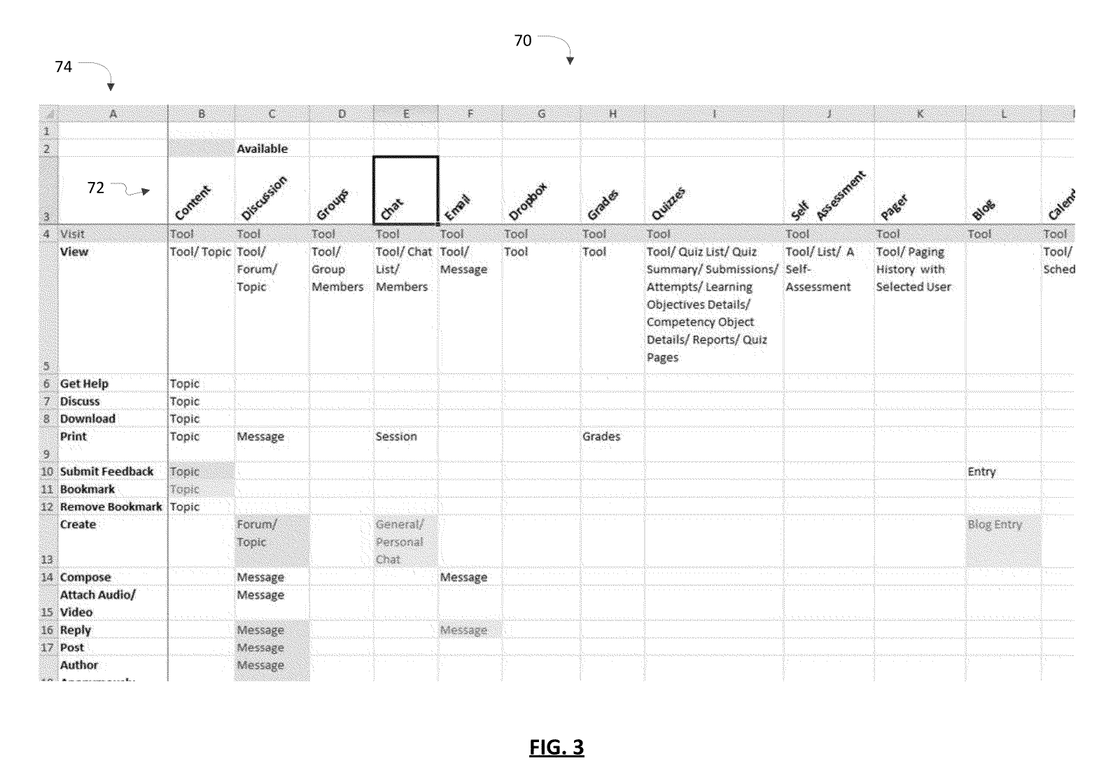

Referring to FIG. 3, illustrated therein is a table 70 showing exemplary course resources 72 and related activities 74 indicative of possible user-interaction with the resources. The available course resources are listed in the columns of the table 70 (e.g. Chat, Email, Dropbox, etc.) and the potential activities are listed in the rows of the table 70 (e.g. View, Download, Print, etc.). As shown, possible activities 74 may vary from one course resource 72 to another.

The course resources 72, for example, may include course content (e.g. reading materials, videos, presentation slides, audio), discussion forums, group collaboration tools, private communication tools (e.g. messaging services, emails), grade reports, assessment tools (self-assessment or otherwise administered), social media tools (e.g. blogs, discussion forums) etc. The activities may include various ways the users may interact with the various resources.

As shown, some exemplary activities include feedback tools, creating new topics or messages, and so on.

In some embodiments, one or more defined learner engagement activities may be organized by categories, types, or domains based upon the nature of the activity. For example, activities relating to and indicative of the attendance of a learner may be grouped together.

In some embodiments, the defined learner engagement activities may include one or more social connectedness activities, such as interaction/discussion posts, messages, emails, questions and answers, etc. Generally, the social connectedness domain may include data elements that capture their graded or ungraded effort to learn through interactions and/or collaboration with one or more other participant in the electronic learning system.

In some embodiments, the defined learner engagement activities may include one or more attendance related activities. Attendance related activities may include number and/or frequency of logins to the system, whether the course content is accessed, and so on. Generally, the attendance domain may include data elements that capture administrative aspects of the educational process, i.e., data points indicative of student presence and actions on administrative stuff.

In some embodiments, the defined learner engagement activities may include participation related activities. The participation related activities, for example, may include posts in discussion forums, accessing course materials, deliverables, grades on assignments, completion of self-assessment, and so on. Generally, the participation domain may include data elements that capture learner's ungraded effort to gain knowledge and skills by reading course material, watching videos, performing self-assessments, etc.

In some embodiments, the defined learner engagement activities may include learner task completion activities. These may include, for example, whether the learner has completed one or more tasks assigned to the learner. The tasks may include reading a discussion forum, watching a video, viewing a presentation, completing a self-assessment quiz, or any other task that the instructor may assign to the learners in the course. Generally, the task completion domain may include data elements that capture required submission of assigned work, quizzes for assessment purpose, and so on.

The monitoring module 50 monitors the defined learner engagement activities for the learners and determine learner engagement values for those activities.

In some embodiments, learner engagement values may be determined by monitoring activities associated with a user identifier, which are in turn associated with one of the learners. For example, the user identifiers 51, 53 shown in FIG. 2 include UID 1 and UID 2. The user identifier UID 1 may be uniquely associated with one of the learners and the user identifier UID 2 with another of the learners whose activities are currently being monitored.

In some embodiments, the monitoring tool 50 and or another component of the system 10 may record various activities associated with the user identifiers 15. For example, UID 1 is associated with records 60, 61 of activities related to resources R1 and R3. Similarly, UID 2 is associated with records 62, 63 of activities related to resources R1 and R2.

The activity records/logs 60-63 of the user identifiers may be generated by various components and or resources of the system 10. For example, some resources may be configured to generate a log entry in a log/record associated with the user identifier each time the user identifier conducts a selected activity associated with the resource. In these cases, the monitoring module 50 may be configured to access activity records 60-63 associated with the user identifier UID 1/UID 2 associated with each of the learners and select entries 60-63 that are relevant to the activities that are being monitored and to determine learner engagement values for those activities.

In some embodiments, the one or more of resources may record various user activities associated with that resource. For example, system login records may have information about which user identifiers 15 assessed the system. As shown in FIG. 2, resources R3 and R4 each log records 64, 65, 66 of user activities associated with the resources R3 and R4. In such cases, the monitoring module 50 may be configured to query each resource R3 and R4 for related records and determine learner engagement values for those activities based on the information in those records 64, 65, 66.

The learner engagement values determined by the monitoring module 50 may include social connectedness values associated with social connectedness activities, attendance values associated with attendance related activities, learner task completion values associated with activities related to the completion of tasks assigned to the learner, and learner participation values associated with learner participation activities.

The methodology of determining learner engagement values for each activity may vary based upon the type of activity and the type of resource. For example, attendance values may be determined based on frequency and/or duration of access to one or more attendance related resources. This may include monitoring how often the user identifier 15 “logs in” or accesses the system or the length of each log in session. Similarly, participation values may be determined by monitoring whether the user identifier 15 has accessed and/or completed one or more of the participation related resources.

The monitoring module 50 may be configured to generate user engagement values at different times. For example, the learner engagement values may be updated at a given interval such as daily, weekly, monthly, or at other predefined intervals. In other examples, the monitoring module 50 may be configured to generate user engagement values upon user request or upon the occurrence of a trigger event. This allows the monitoring module 50 to provide a relatively current “snapshot” of the learner engagement values for learners in the system 10.

Generating learner engagement values in such a manner may be different from some traditional performance prediction models which predict a learner's overall performance based upon the learner's performance in one or more assessment modules. For example, a traditional performance prediction model may predict how well a user will perform in a given course to the user's performance in intermediate assessment modules (such as quizzes, midterms, assignments, etc.).

Furthermore, the embodiments disclosed herein generally allow for a more detailed collection of data. For example, some traditional performance prediction models will predict academic success based upon attendance in classrooms. Such models use aggregated data that are obtained historically. For example, the data obtained by the models may include overall attendance of each of the monitored students and their final grades (e.g. 80% of the students who attended 90% of the classes received an “A” grade). However, it may not be possible to determine what is the likelihood of success for a learner at a given point in the course. For example, as the data in the traditional models relates to overall attendance, it may not be accurate in predicting likelihood of success for a learner 10 days into the course, 20 days into the course, 30 days into the course and so on.

The monitoring module 50 provides the learner engagement values for various defined learner engagement activities to the performance prediction module 52. In addition to the learner engagement values, the performance prediction module 52 may also receive learner preparedness value from the learner preparedness module 58.

For each of the learner engagement activities, the performance prediction module 52 is adapted to compare learner engagement values for that activity with the historical values (and the corresponding historical performance data for that activity) to determine a performance prediction value for that activity. The performance prediction module 52 is also configured to generate a combined or aggregate performance value for the learner based upon performance prediction values for the activities. In some embodiments, the learner preparedness values may also be included when generating the combined performance value.

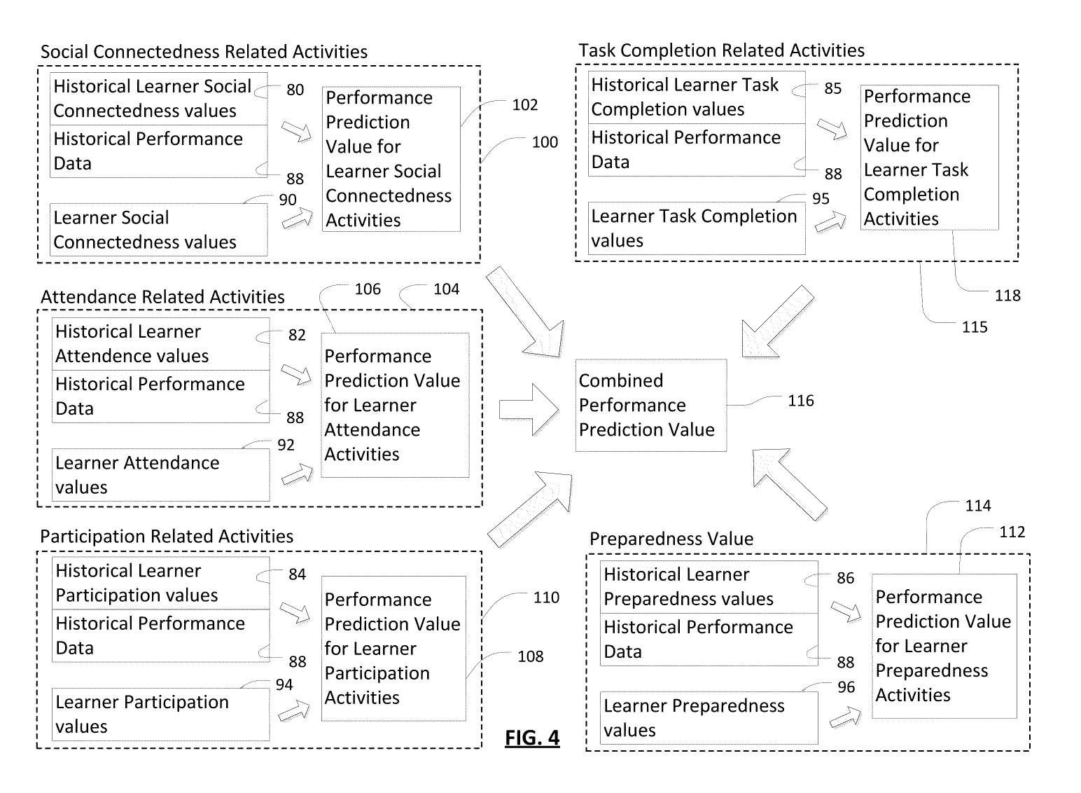

Referring now to FIG. 4, illustrated therein is a schematic diagram showing how the performance prediction module 52 may determine a performance prediction value for each activity and a combined performance prediction value according to some embodiments.

As shown, four types or categories of learner engagement values are received from the monitoring module 50. These include learner social connectedness values 90, learner attendance values 92, learner participation values 94 and learner task completion values 95. In other embodiments the number and or type activities of the learner engagement values received by the monitoring module 50 may differ.

The learner social connectedness values 90 are indicative of the social connectedness activities of the current learners. Similarly, the learner attendance values 92 are indicative of the attendance related activities of the current learners, the learner participation values 94 are indicative of the participation related activities of the current learners, and learner task completion values 95 are indicative the task completion related activities of the current learners.

In addition to the learner engagement values received from the monitoring module 50, the performance prediction module 52 may receive preparedness values 96 for the current learners from the learner preparedness module 58.

The learner preparedness values 96 are indicative of how prepared each of the current learners are for the course. This value 96 may be determined by the learner preparedness module 58 based upon the academic history of each particular learner. For example, this value 96 may be determined based upon whether the learner had completed other courses that are related or supplemental to the current course. In another example, this value 96 may be determined based upon the performance of the learner in one or more courses that are prerequisites to the current course. In another example, this value 96 may be determined based upon performance of the learner in a number of courses, regardless of whether those courses are related to the current course, such that the value provides an indication of the overall academic strength of the learner. In another example, this value 96 could be determined based on a weighted combination of several of these factors.

In some other embodiments, the performance prediction module 52 may not receive any learner preparedness values 96. For example, if the current course is a basic level introductory course offered to current students who are new to the institution, there may not be any learner preparedness values 96 that are relevant and would be received by the performance prediction module 52.

In addition to the learner engagement values 90, 92, 94, 95 and learner preparedness values 96, the performance prediction module 52 also receives historical data from the data storage device 56. The historical data includes historical learner engagement values for the learner engagement activities and the corresponding historical performance data associated with one or more learners who had previously completed one or more selected courses.

In some embodiments, historical data may be obtained from various databases and data sources. For example, the historical data may be obtained from a single institution, a plurality of institutions, or third party data services.

In some embodiments, historical data may include historical data associated with all of the courses in an institution. In other embodiments, historical data may include historical data associated with selected courses. The selected courses may be related to the current course. For example, the selected courses may have similar features (e.g. they use certain course resource types or are from the same faculty) or share a similar overarching theme (e.g. they are all mathematics courses, science courses, etc.).

In some embodiments, historical data may only be drawn from certain groups of learners who meet certain criteria. For example, historical data may be drawn only from learners who are within a certain age group.

In some cases, there may be no existing historical data. In such cases, “historical” data could be built-up by using the monitoring modules to monitor user engagement values at regular intervals. Upon completion of the course and provision of the performance data, the user engagement values and the corresponding performance data may be stored in the database. The monitoring module 50 may be configured to do this as indicated generally by reference numeral 55 in FIG. 2. This stored data can then be used as historical data in subsequent implementations of the system 10.

Even when historical data exists, it may be desirable to record the learner engagement values and corresponding performance data for the current batch of students in a database (e.g. the database 56). This will allow the available historical data to increase with each batch of students. Having a larger amount of data may improve the usefulness of the dataset, for example, by allowing filtering of the existing data remove statistical abnormalities.

In the embodiment as shown in FIGS. 2 and 4, the historical learner engagement values received from the database 56 include historical learner social connectedness values 80, historical learner attendance values 82, historical learner participation values 84, historical learner preparedness values 86, and historical learner task completion values 85. Generally, the received historical learner engagement values 80, 82, 84, 85 would relate to the learner engagement values for the current learners in that they are associated with the same, similar, or related activities and or related resources.

The historical learner social connectedness values 80 are indicative of social connectedness activities of historical learners. Similarly, the historical learner attendance values 82 are indicative of attendance related activities of historical learners, and historical learner attendance values 82 are indicative of participation related activities of historical learners. The historical learner preparedness values 86 are indicative of how prepared the historical learners were and the historical learner task completion values 85 are indicative of how much of the assigned tasks did the historical learners completed.

In some embodiments, one or more of these historical learner engagement values 80, 82, 84, 85 may have been obtained from the historical learners by monitoring the same activities associated with the same resources as the current learners in the course. In other embodiments, these values 80, 82, 84, 85 may be obtained from monitoring one or more activities and/or resources that are different from the activities and associated resources monitored for the current learners in the course.

In addition to the historical learner engagement values 80, 82, 84, 85, 86, corresponding historical performance data 88 is also received by the performance prediction module 52. The historical performance data 88 is indicative of the performance of the historical learners in the one or more selected courses. This data 88 may include information relating to the overall performance of the historical learners in the selected courses, such as information about the historical learners' grades, how they ranked relative to their peers, and so on.

In some embodiments, the historical performance data 88 associated with one of the historical learner engagement values 80, 82, 84, 85, 86 may be different from historical performance data 86 associated with other historical engagement values 80, 82, 84, 86. For example, in cases where the sources of historical learner engagement values 80, 82, 84, 86 differ between one another (e.g. if historical learners differ or the selected historical courses differ) then the historical performance data corresponding to historical learner engagement values 80, 82, 84, 86 may also differ.

Generally, the performance prediction module 52 is adapted to, for each type of activities, compare learner engagement values for that type of activities with the historical values and the corresponding historical performance data for that type of activities to determine a performance prediction value for that type of activities. In some embodiment, each type of activities may include just one activity rather than a plurality of activities.

The performance prediction module 52 is configured to determine performance prediction values for each of the activities after receiving, for each activity, associated earner engagement values 90, 92, 94, 95, 96 for the current learner, historical learner engagement values 80, 82, 84, 85, 86, and corresponding historical performance data 88.

In some embodiments, a logistic regression or neural network model may be applied to the historical data and current learner engagement values to determine performance prediction values. In some embodiments, other methods (e.g. other statistical methods) may be used to determine performance prediction values.

In some embodiments, the type of method used may be determined based on the learner engagement values. That is, the method that is applied to determine performance prediction values may be domain-dependent. Some exemplary domains include Attendance, Participation, Completion and Social Learning. This may be advantageous in that a suitable method to determine the performance prediction value can be applied independently for each domain. Each domain may provide semantically meaningful logical units from the perspective of the educational institution (e.g. teaching and learning perspectives).

Given that several sets of data are collected from various domains, where the nature and meaning of the user interactions are different, a single model may not be suitable to process the information from various domains in a meaningful and interpretable way.

In some embodiments, in the social connectedness domain, graphical models that are suited for statistical inference on network-type data may be applied. Furthermore, these graphical models can be used in conjunction with text mining techniques to analyze the learners discourse and extract predictive features that best discriminate between risk patterns in social interactions and patterns of constructive collaborations/discussions.

In some embodiments, in the participation domain, predictive models that are designed for the classification of sequence (time series) data may be applied. This may be effective in determining learner performance values in this domain as learning may be dependent on the order in which students study the course materials and solve practice exercises.

In some embodiments, in the attendance domain, a logistic regression model may be implemented to determine learner performance prediction values.

In general, ensuring that a single hypothesis (predictive modelling algorithm) matches the properties of the data is important for providing predictions that meet the needs of the application area. One way in which the issue of this algorithm/application match can be alleviated is by using ensembles of predictive models, where a variety of models are pooled before a final prediction is made. Ensembles allow the different aspects of a complex phenomenon to be handled by models suited to those particular aspects. Mathematically, classifier ensembles provide an extra degree of freedom in a classical issue known as the bias/variance trade-off, allowing solutions that would be difficult (if not impossible) to reach with only a single model.

In the embodiments as shown in FIGS. 2 and 4, the performance prediction module 52 determines a performance prediction value 102 for learner social connectedness activities 100 based upon the learner social connectedness values 90 for the current learner and the historical learner social connected value 80 and historical performance data 88. This may be done, for example by comparing the learner social connectedness values 90 to historical learner social connectedness values 80 and noting the corresponding performance data 88.

The performance prediction module 52 also determines a performance prediction value 106 for learner attendance activities 104 based upon the learner attendance values 92 for the current learner and the historical learner attendance value 82 and historical performance data 88. This may be done, for example by comparing the learner attendance values 92 to historical learner attendance values 82 and noting the corresponding performance data 88.

The performance prediction module 52 also determines a performance prediction value 108 for learner participation activities 110 based on the learner participation values 94 for the current learner and the historical learner participation value 84 and historical performance data 88. This may be done, for example by comparing the learner participation values 94 to historical learner participation values 84 and noting the corresponding performance data 88.

The performance prediction module 52 also determines a performance prediction value 114 for learner preparedness component 112 based on the learner preparedness values 96 for the current learner and the historical learner preparedness value 86 and historical performance data 88. This may be done, for example by comparing the learner preparedness values 96 to historical learner preparedness values 86 and noting the corresponding performance data 88.

The performance prediction module 52 also determines a performance prediction value 118 for learner task completion activities 115 based upon the learner task completion values 95 for the current learner and the historical learner task completion value 85 and historical performance data 88. This may be done, for example by comparing the learner task completion value 95 to the historical learner social connectedness values 85 and noting the corresponding performance data 88.

After the performance prediction values 102, 106, 110, 114, 118 for each type of activities are calculated, the performance module combines the individual values to determine a combined performance prediction value 116. In some embodiments, the individual performance values 102, 106, 110, 114, 118 may be weighted when determining the combined performance prediction value 116 to reflect the importance of the different types of activities in predicting the performance for the current learners.

In some embodiments, a trainable or a non-trainable method may be used to determine the combined performance prediction value 116. In some embodiments, this selection may be done based upon user input.

If a non-trainable method is selected, the user may be presented with the option to gage the weights assigned to each model, or choose equal weights. System-recommended weights could also be determined based on the estimated probabilities generated by each model. For example, a model may predict that a student is at risk with probability 0.99 or 0.51. This probability value would be used to assign the relative weights for each classifier decision as a measure of confidence in the decision.

If a trainable method is selected, a predictive model is trained to estimate the optimal combination of weights.

The combined performance prediction value 116 provides an overall picture of how well (or poorly) each current learner is predicted to perform based upon the activities of that learner and historical data.

After generation, the performance prediction values 102, 106, 110, 114, 118 and the combined prediction value 116 are provided to the visualization module 54 (which also receives the learner engagement values 90, 92, 94, 96 from the monitoring module 50 and the learner preparedness module 58). The visualization module 54 is configured to generate one or more visual displays to convey the received data.

In some embodiments, one or more of the modules 50, 52 may be configured to send a notification to a designated user of the system if the performance prediction value for a type of activities or the combined performance prediction value 116 is above or below a defined value. For example, instructors, administrative staff, and/or the learner may be notified of the performance prediction values.

In some embodiments, the visualization module 54 may be configured to generate at least one visual display charting the learner engagement values and the combined performance prediction value for that selected learner relative to the historical learner engagement values and corresponding historical performance data.

In some embodiments, the visualization module 54 may be configured to generate at least one visual display charting performance prediction values for one or more of the learner engagement activities relative to the combined performance prediction value.

In some embodiments, the combined performance prediction value may be generated for and be associated with one of the courses that the learner is completing. Additional performance prediction values corresponding to one or more other courses that the learner is completing may also be generated.

The combined performance prediction value may be viewed as a risk indicator. For example, the performance prediction value may be used to determine whether the learner is at-risk for poor academic performance or poor user engagement. This may be more advantageous than traditional systems that only rely on grades as an indication of performance. For example, it is possible that a user may be under-engaged even though he or she is receiving good grades. In such cases, the user may be at-risk of dropping out because of this under-engagement, and as such remedial or corrective can be suggested.

In some embodiments, the visualization module 54 may be configured to generate at least one visual display charting one or more of the learner engagement values in relation to corresponding historical learner engagement values.

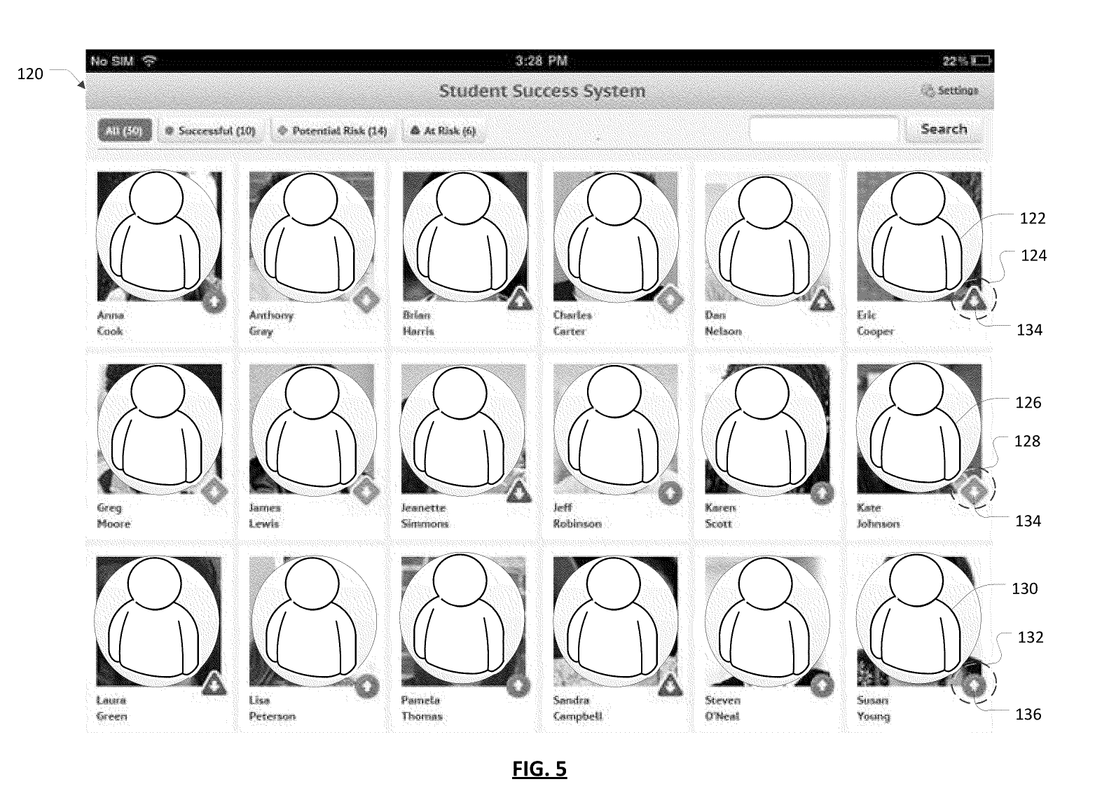

Referring to FIGS. 5-10, illustrated therein are examples of visual displays generated by the visualization module according to some embodiments. A first visual display 120, shown in FIG. 5, provides an overview of the learners (e.g. learners 122, 126, 130) in an institution. Each of the learners 122, 126, 130 has an associated performance indicator 124, 128, 132. Each of the performance indicators 124, 128, 132 provides an indication of the overall predicted performance of that learner in one or more courses that the learner is currently completing. In particular, the overall learner engagement could be determined based upon combined performance prediction value 116 for each of the courses that the learner is taking. For example, the performance prediction module 52 or the visualization module 54 may be further configured to determine an institutional-level overall performance prediction value based upon course-level combined performance prediction values.

As shown, the indicator 124 is may be shaped as a triangle, which and is used to indicate that the specific learner 122 (Eric Cooper) is at-risk for an undesirable outcome. In some cases the user may interact with the icon or the visual display 120 to determine why the learner 122 is at risk, and what he or she is at risk for.

The indicator 128 is a diamond and is used to indicate that the particular learner 126 (Kate Johnson), is somewhat at-risk (i.e. caution).

On the other hand, the indicator 132 is a circular in shape and is used to indicate that the specific learner 130 (Susan Young) is not at-risk. In other embodiments, other shapes or types of indicators may be used.

For example, the indicators 124, 128, 132 may also incorporate colour to convey at-risk information. For example, the at-risk triangle indicator 124 may be coloured red, the cautionary at-risk diamond indicator 128 may be coloured yellow and the not at-risk (or “safe”) circular indicator 132 may be coloured green.

Each of the indicators 124, 128, 132 as shown also has an upward directional arrow 136 or a downward directional arrow 134 within the indicator which may be used to indicate trending information. In particular, the downward directional arrows 134 may indicate that the overall learner engagement value for that learner has decreased, for instance when compared to the last time the overall learner engagement value was calculated. Conversely, the upward directional arrow 136 may indicate that the overall learner engagement value has increased.

The indicators 124, 128 and 132 provide an efficient way of conveying overall predicted performance of the learners in all of the courses, for example whether the learners are at risk and whether the learners are becoming more or less engaged in the courses.

In some embodiments, the indicators may be used to convey overall learner engagement information, which may be generated using the learner engagement values determined by the monitoring module 50.

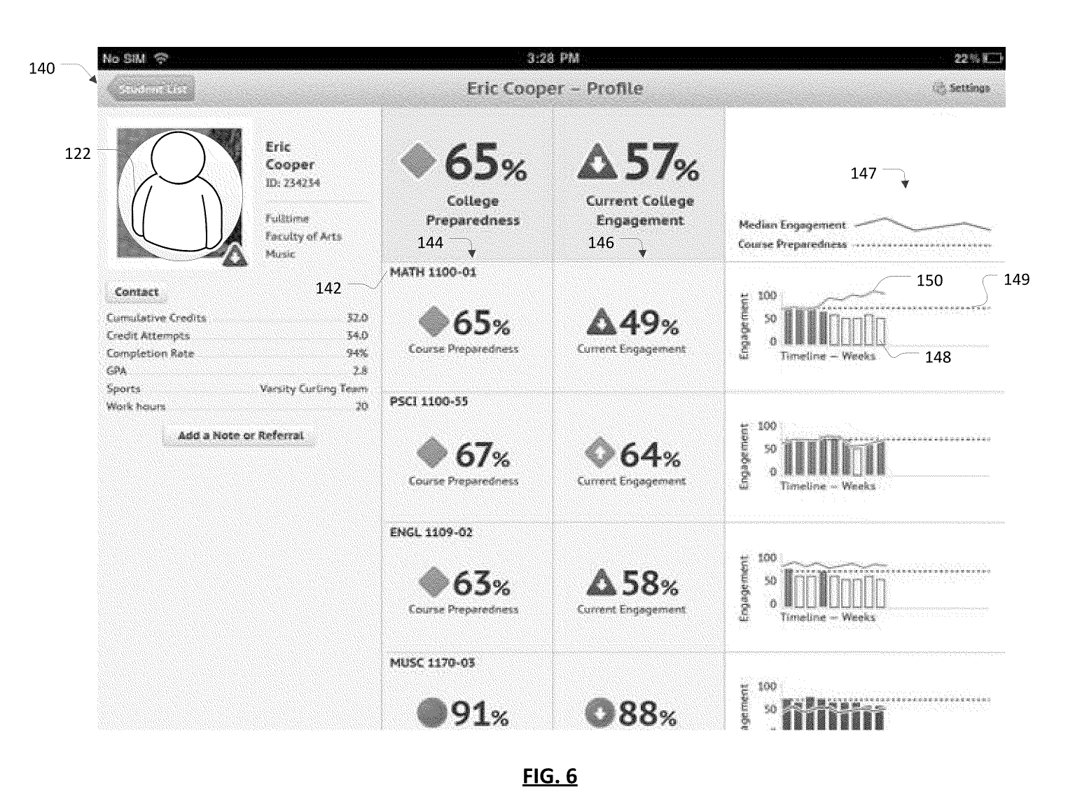

Referring now to FIG. 6, illustrated therein is a second visual display 140 providing more in-depth learner engagement information about a particular learner 122 (Eric Cooper). The second visual display 140 may be displayed, for example, in response to a user clicking on a portrait of one of the learners 122, 126 or 130 shown in the first visual display 120. As shown, the second visual display 140 contains additional information about the learner 122 (e.g. student ID number, Faculty, credits completed, etc.).

The second visual display 140 may include a course-by-course break down of the information about the learner. The courses may be displayed in a row, and for each course (e.g. course 142) the associated information may be displayed in a row.

Learner preparedness values, generally indicated by reference numeral 144, are provided for each course. These values 144 may be the learner preparedness value 96 as determined by the learner preparedness module 58.

Similarly, course engagement values, generally indicated by reference numeral 146, are also provided for each course. These values 146 may be the combined performance prediction value 116 as determined by the performance prediction module 52.

The second visual display 140 may also include a graph 147 for each course. The graph 147 plots time vs. engagement in the horizontal-axis and vertical-axis respectively. The bars 148 may be indicative of the learner engagement values for that course taken a various time periods, which in this case is in weeks. The solid line 150 shows the median engagement of all of the learners in the class while the stippled line 149 shows the course preparedness for that learner 122.

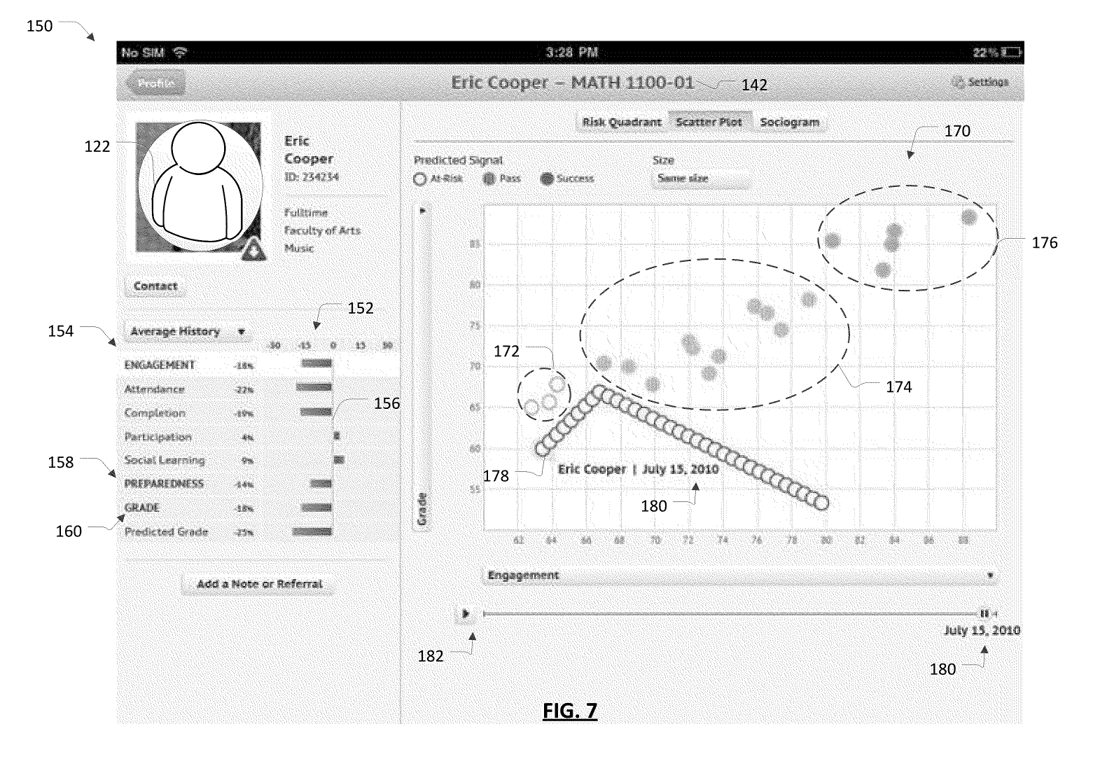

Referring now to FIG. 7, illustrated therein is a third visual display 150 providing even more in-depth information about learner engagement values associated with the learner 122 (Eric Cooper) in a course (MATH 1100-01). In this example, the visual display 150 shows learner engagement values associated with the learner 122 and the course 142.

The third visual display 150 includes a graph 152 (e.g., a win-loss chart) of the learner engagement values (generally indicated by reference numeral 154) for various categories of learner engagement activities plotted against the median values of the class for each of the categories. In some cases, the values may be plotted against the learner's historical values. The median value is indicated by the line 156 in the graph 152. The learner engagement values 154 may be the learner engagement values 90, 92, 94, 95 for various activities that are obtained by the monitoring module 50.

The graph 152 also plots learner preparedness value 158, the learner's current grade 160 and predicted grade 162 against corresponding median values. The predicted grade 162 may be based on the combined learner performance value 116 for the course as determined by the performance prediction module 52.

The third visual display 150 also includes a scatter plot 170 which shows one or more data points from historical learner engagement values and corresponding performance data in relation to the learner engagement values for the current learner 122. Each data point (e.g. data point 171) represents a learner who had previously completed the course. The scatter plot 170 has learner engagement values in the horizontal axis and the grades on the vertical axis and the data points and the current learner information are graphed accordingly.

As shown, the scatter plot 170 plots nineteen historical data points based on grouped in to three groups 172, 174, 176. The first group 172 includes data points of historical learners who had performed poorly in the course. The second group 174 includes historical learners who had performed generally average and the third group 176 includes historical learners who had performed well in the class.

It can be observed form the scatter plot 170 that historically, there has been a correlation between the learner engagement values and learner performance. That is, historically higher learner engagement values generally correlate to higher grades.

The scatter plot 170 also includes various data points (e.g. data point 178) associated with the specific learner 122. Each of the data points is obtained at a selected time period. For example, each data point may be obtained weekly. As shown the data point 178 associated with the learner 122 is obtained on Jul. 15, 2010 as indicated by reference numeral 180. A control 182 could be used to highlight data points associated with the learner which are obtained at different time periods. As shown the date 180 is the most current data point for the learner. The scatter plot 170 is also dynamic in the sense that data can be animated to visualize paths/trails depicting changes in learner behaviors and performance over time.

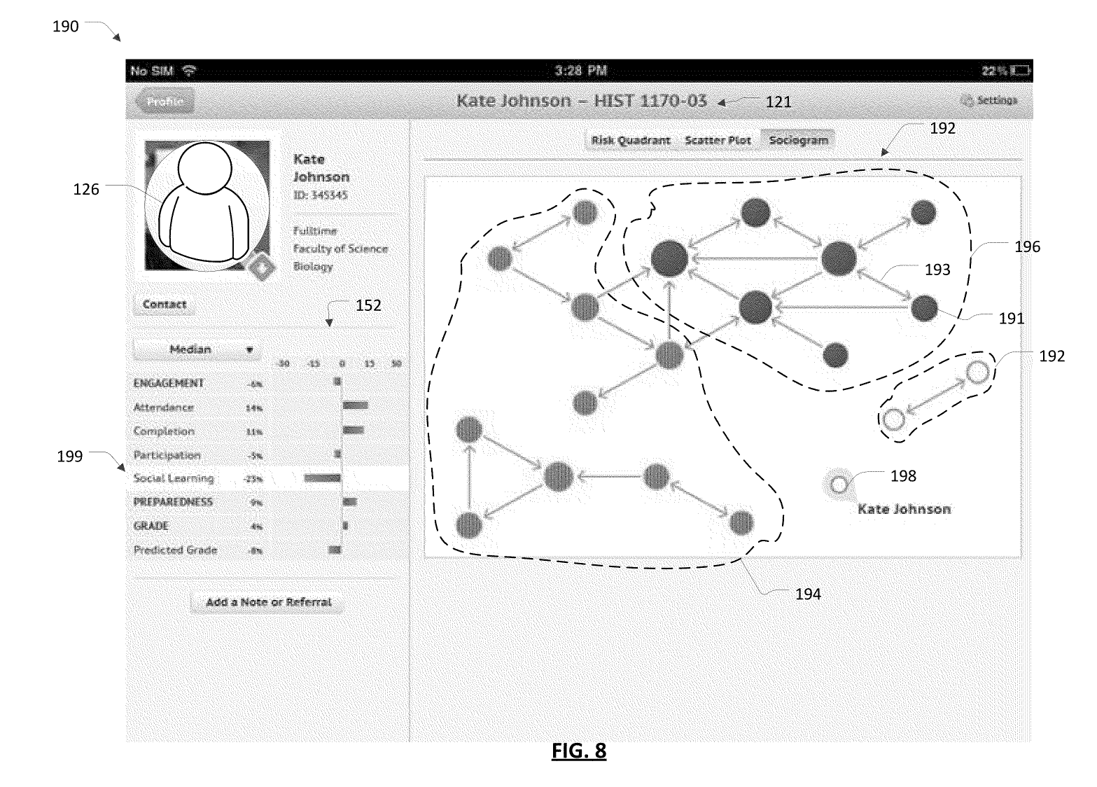

Referring now to FIG. 8, illustrated therein is a fourth visual display 190 providing social connectedness information between learners in a course. The display 190 as shown is associated with the learner 126 (Kate Johnson) in the class indicated by reference numeral 121 (HIST 1170-03). The display 190 shows patterns of communication or collaborations among learners. It is depicted as a network with nodes representing learners and links representing interactions. Size, colors, and link width may be used to indicate relevant variables. Furthermore, statistical and topological measures may be used to describe patterns, cluster structures and other characteristics, and to evaluate the health of individual social learning and of the overall learning community. As part of the analysis of this domain, text mining, cognitive and learning theory may be applied to extract relevant factors of learning success and to identify at-risk learners

The display 190 includes a sociogram 192 showing the interaction between different learners in the class 121. Each circular indicator (e.g. indicator 191) represents one of the learners in the class. The arrows (e.g. arrow 193) linking the indicators represent communication between the learners. In some embodiments the sociogram 192 could be generated based on the data obtained by the monitoring module 50 related to social connectedness activities.

The indicators are organized into three groups 192, 194, 198 based upon social connectedness values of the learners. The indicators in each group may be assigned a similar colour that is different from a colour of indicators other groups so as to provide visual representation of how socially connected each learner is. Furthermore, the size of the indicator may also be used represent the social connectedness of the learner associated with the learner (e.g. larger symbols indicate greater degrees of social connectedness, and so on).

As shown, the learner 126 (Kate Johnson) is represented by indicator 198 and is not socially connected to any other learner. This information is reflected in the learner engagement values graph 152. The graph 152 is similar to the graph 152 shown in FIG. 7, but is adapted to display the values for the learner 126 instead of the learner 122. As shown, the social connectedness value for the learner 126 is significantly below the median social connectedness value for that class (as indicated by reference numeral 199). However, it can also be observed from the graph that the learner attendance value and the learner task completion value of the learner 126 are above the median values for the class. In some such cases, an instructor may not need to be overly concerned with the performance of the learner 126 as some learners prefer to learn individually. In other cases, however, this low social engagement may still be a cause for concern.

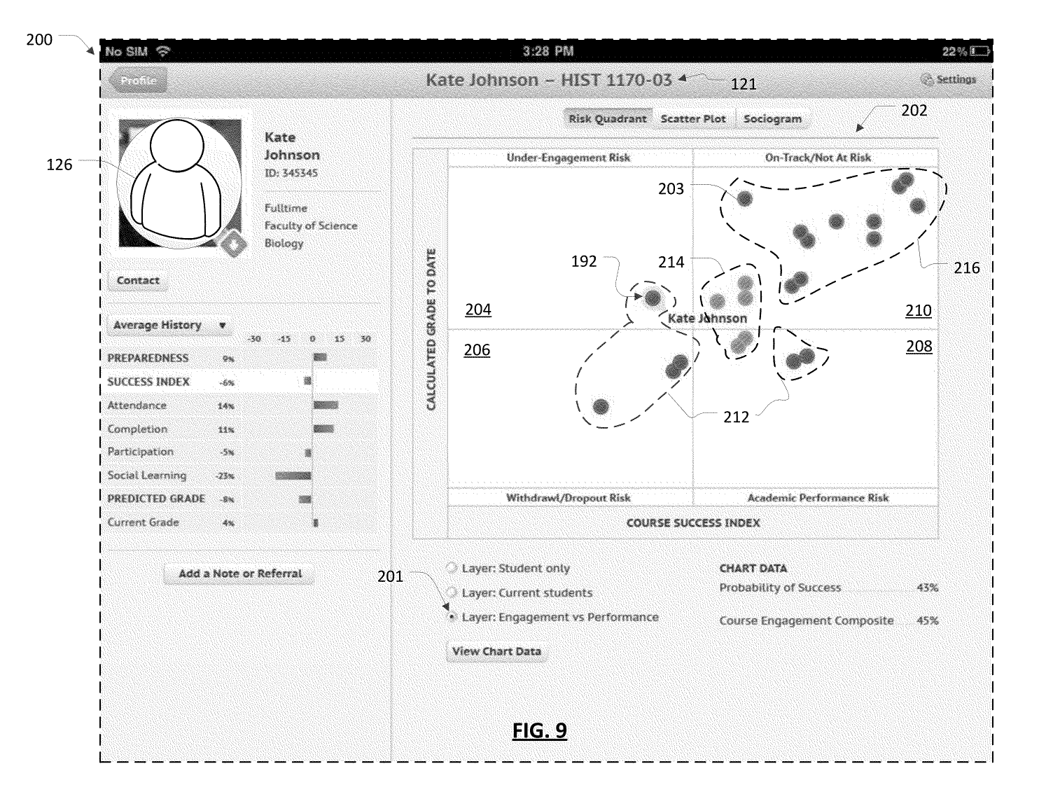

Referring now to FIG. 9, illustrated therein is a fifth visual display 200 providing a risk quadrant diagram 202 mapping risk of the information between learners in a course. The display 190 as shown is associated with the learner 126 Kate Johnson in the class indicated by reference numeral 121 (HIST 1170-03).

The diagram 202 displays various risks associated with the learner 126. The calculated grades to date are provided on the vertical axis and the course success index is provided along the horizontal axis. The course success index may be the combined performance prediction value 116 for the course.

As shown, the diagram 202 has two lines dividing the graph into four risk quadrants. Each of the quadrants represents a risk associated with a learner placed in that quadrant. The learners who are at risk for under-engagement are placed in the upper left risk quadrant 204. The learners who are at risk for withdrawing from the class or dropping-out of the system are placed in lower left risk quadrant 206. The learners who are at risk for poor academic performance (e.g. predicted to receive a D or F grade in the course) are placed in lower right risk quadrant 208. The learners who are on-track and are generally not at-risk for the above noted outcomes are placed in the upper right quadrant 210.

Each data point (e.g. data point 203) in the risk quadrant diagram 202 represents one of the learners who are currently completing the course. In some embodiments, each data point may represent a plurality of learners and the size of the data point may relate to the number of learners that it represents. The placement each the data point 203 onto one of the risk quadrants is determined based upon the associated learner's combined performance prediction value 116 for the course and his or her calculated grades to date.

The learners are grouped into three different groups 212, 214, and 216. Learners in group 212 are identified as being at-risk for under engagement, withdrawal/dropout and/or poor academic performance. The learners in group 214 are identified as somewhat at-risk (i.e. at-risk but not to the same extent as the learners in group 212) for the same outcomes as group 212. The learners in group 216 are generally not at-risk. Similar to other diagrams, indicators of data points in each group may be assigned a similar colour or other visual indicator that is different from the colour of indicators other groups so as to provide visual representation of how socially connected each learner is.

In the risk quadrant diagram 202 as shown, learner 126 is flagged as being at-risk for under-engagement and the indicator for her data point 192 is located in the upper left risk quadrant 204.

The information presented in the risk diagram could be modified selecting one or more of the options 201. For example, additional layers could be added or other risk quadrants could be introduced.

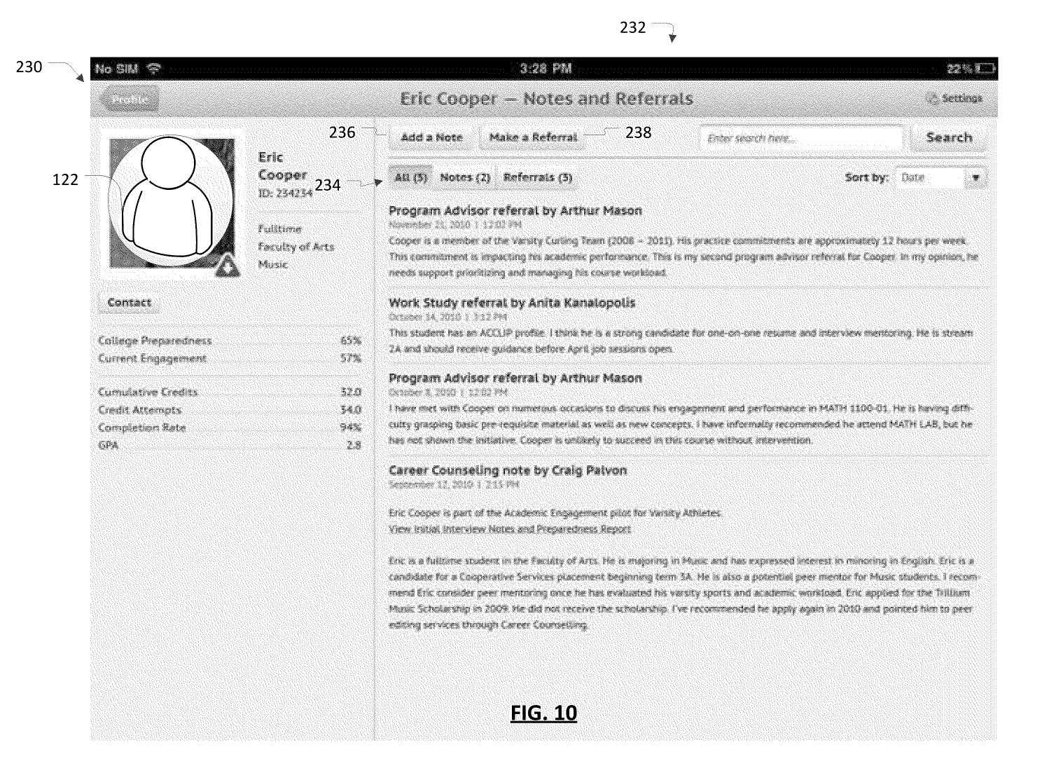

Referring now to FIG. 10, illustrated therein is a sixth visual display 230 providing an interface 232 which may be used to prescribe actions that can help at-risk learners. The display 230 as shown is associated with the learner 122 (Eric Cooper).

The interface 232 is adapted to provide notes and referrals, generally indicated by reference numeral 230 associated with the current learner 122. The interface 232 also provides options for the user reviewing the interface to add his or her own notes and/or referrals. For example, the user may click on button 236 to add a note, or click on button 238 to add a referral. Existing notes and referrals for the learner 122 are generally indicated by reference numeral 234.

In some embodiments, a recommendation module (not shown) may be provided. The recommendation module may be adapted to provide suggested corrective actions that are relevant to the context in a visually informative way. For example, an overall success prediction may be delivered on the course home page, whereas domain-related predictions would be delivered as the learner accesses various course tools/resources. For example, when learners visit a discussion forum, the social learning component of the success indicator may be delivered and compared against the values for their peers and or historical values. The learners may also be shown their position within the sociogram or other relevant visuals (with privacy considerations).

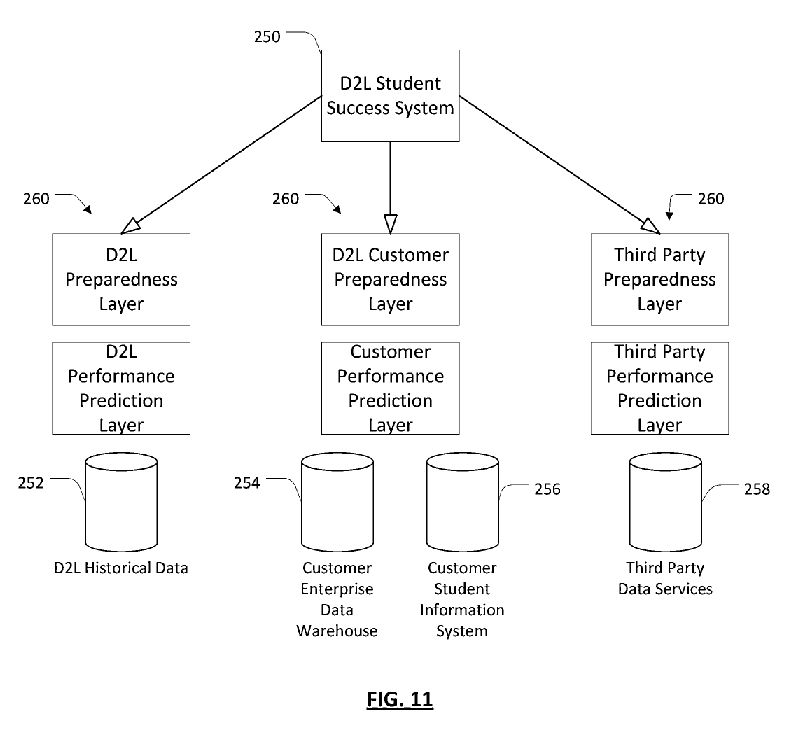

Referring now to FIG. 11, illustrated therein is an exemplary IT infrastructure that may be used to implement a student success system 250 according some other embodiments. The student success system 250 may be the same as or similar to the system 10 as described above in that the system 250 may include one or more of the modules 50, 52, 52, 54 that are configured to implement the system for monitoring and predicting user performance.

In the embodiment as shown, the system 250 obtains historical data from four data sources, in particular from a historical database 252. The database 252 may include historical learner engagement values and corresponding data of students that had previously used the system 250. This may include data from learners from different institutions and so on.

The system 250 may also uses historical data from a customer enterprise data warehouse 254 and customer student information system 256. These customer databases 254 and 256 may include historical data that are proprietary to a customer institution (e.g. an educational institution) that uses the system 250.

The system 250 also uses third party data services 258. These third party data services 258 may include historical data that can be obtained from a third party source (i.e. not the customer institution).

In the embodiment as shown, various layers 260 are provided such that the historical data from various sources could be used.

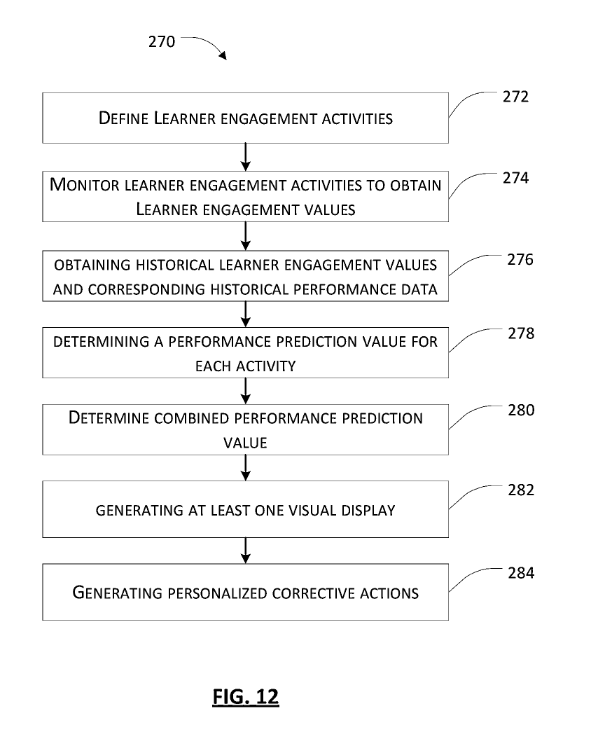

Referring now to FIG. 12, illustrated therein is a method 270 for predicting performance of at least one learner according to some embodiments. One or more processors, for example the processors of the servers 32 shown in system 10, could be configured to implement the method 270. In particular, in some embodiments, the processors may be configured to provide one or more modules, for example, one or more of the modules 50, 52, 54, 58 which are adapted to perform one or more of the steps of the method 270.

The method 270 begins at step 272 wherein a plurality of learner engagement activities are defined. These activities may include attendance related activities, participation related activities, social connectedness related activities, task completion related activities, and/or other activities.

At step 274, the learner engagement activities defined in step 272 are monitored to obtain learner engagement values associated with each of the learner engagement activities. These values may include learner attendance values, learner participation values, learner social connectedness values, and/or learner task completion values.

At step 276, historical values for the learner engagement activities and corresponding historical performance data is obtained from one or more databases.

At step 278, a performance prediction value for each learner engagement activity (or each group of activities) is determined by comparing the current values for the learner engagement activities (e.g. learner engagement values) to the historical values for the same (i.e. historical learner engagement values).

At step 280, a combined performance prediction value for that learner for the course is determined based upon performance prediction values for each activity (or each group of activities).

At step 282, at least one visual display is generated based on the learner engagement values and/or the performance prediction values by activity, or the combined performance prediction value. These visual displays could be as generally described above with respect to FIGS. 5-10.

At step 284, personalized corrective actions may be determined for the learners who are at-risk. These corrective actions may be generated based upon user input, after the user is presented with various visual displays so as to encourage diagnostic insights related to the root cause of why the learner is at risk.

The embodiments described herein above may entail certain advantages. For example, in some cases they may synthesize several strands of risk analytics: the use of predictive models and segmentation to identify academically at-risk students, the creation of data visualizations to promote instructors to develop diagnostic insights, and the application of a case-based approach for managing interventions.

Furthermore, the embodiments address two limitations in traditional approaches to building predictive models in learning analytics. The first limitation is the ability to generalize across different learning contexts. In other words, the embodiments described herein may allow predictive models that generalize across different courses, different institutions, different pedagogical models, different teaching styles, and different learning designs to be created.

The second limitation is the ability to interpret the results of a prediction for the purpose of decision and action. That is, it may be difficult for a non-technical practitioner (e.g. an advisor or an instructor) to design meaningful interventions (e.g. prescribe corrective actions) for the at-risk individual learners when the underlying mechanism of how the at-risk value is calculated is unknown to the practitioner.

The embodiments described herein may apply an ensemble method for predictive modelling which allows a predictive model based upon a plurality of customizable factors to generate an overall prediction value, which can then be decomposed to its constituent factors. The factors that are monitored could be organized into semantic units (e.g. attendance, preparedness, task completion, social connectedness, etc.) and the overall value could be decomposed into the semantic units. Decomposition provides a flexible mechanism for building predictive models that can be applied in multiple contexts.

Decomposition of the overall at-risk value into its constituent semantic units provides is desirable in that it allows users to review various components of the at-risk values and develop diagnostic insights and prescribe personalized interventions based upon which of the semantic units are driving the overall at-risk value.

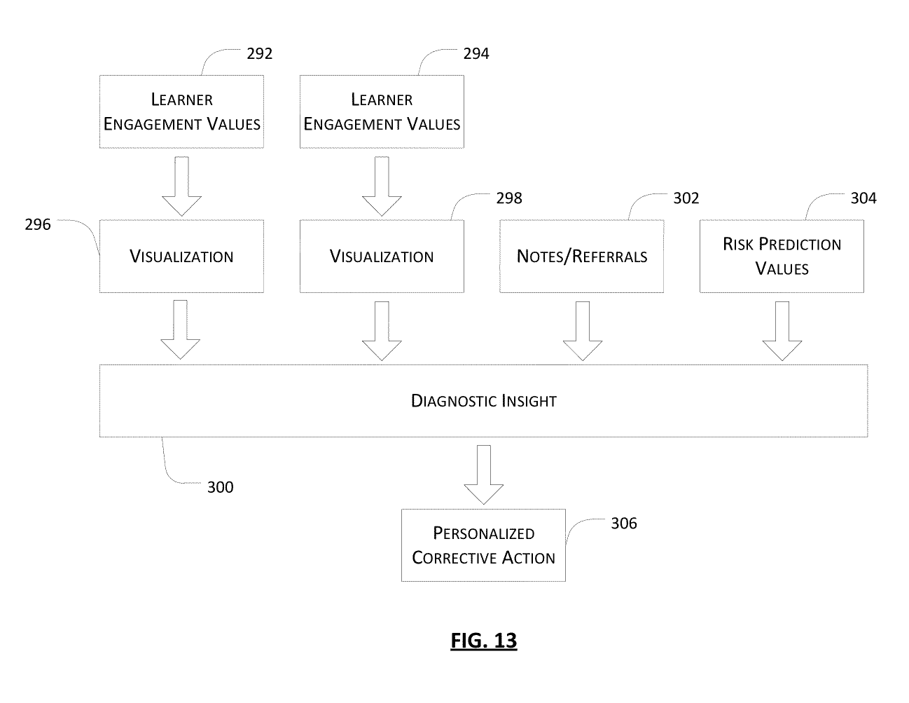

Referring now to FIG. 13, illustrated therein is a schematic diagram showing how a user may develop diagnostic insights 300 and design personalized corrective action 306 according to some embodiments described herein.

As shown, learner engagement values 292 and 294 associated with a learner are presented using visualizations 296 and 298 respectively. The learner engagement values 292, 294 could include one or more of the learner engagement values described herein and the visualizations 296, 298 could include one or more visual displays described herein (e.g. the interactive scatter plot 170 shown in FIG. 7).

In addition to the visualizations 296, 298, existing notes/referrals for the learner (e.g. notes/referrals 234 shown in FIG. 10) and a risk prediction value (e.g. course related combined performance prediction value 116 or overall risk prediction value described herein above) may be helpful to the user to develop diagnostic insights 300. The user may then design and prescribed personalized corrective action (e.g. an intervention) for the learner based upon the information. The correction action could be included as a note or a referral so that such information is available to other subsequent users (e.g. administrators, etc.).

The embodiments described herein generally combine several strands of risk analytics theory to identify learners who are at-risk for poor academic performance. Some embodiments employ a combination of various hypothesises to identify the at-risk students, provide data visualizations designed to encourage diagnostic insights by the instructors reviewing the visualizations, and apply a case-based approach for managing interventions.

The methodology for generating predictive models is flexible to allow generalization from one context to another. Furthermore, the underlying prediction mechanisms may be readily interpretable by practitioners who may engage the system to design meaningful interventions for at-risk students.

In some embodiments, the system includes an ensemble method for predictive modelling by combining various hypotheses (factors) that may predict a learner's ability to succeed. The system also includes decomposition techniques for generating and generalizing predictive models across different contexts. Decomposition provides transparency for the instructors such that they are able to view which of the factors are driving the performance prediction for a given student. Decomposing performance predictions for the students into interpretable semantic units, when coupled with data visualizations and case management tools, allows practitioners, such as instructors and advisors, to build a bridge between prediction and intervention.

In some embodiments, domain-specific decomposition allows for the development and integration of specialized models and algorithms that are best suited for different aspects of learning. For example, in the embodiments described above, the combined performance prediction module is decomposed to provide an abstraction of learning behaviour into semantically meaningful units.

Various embodiments described herein may be viewed as enabling a collaborative platform, whereby an institution can plug its own proprietary model as part of the ensemble. Thus, it enables an open, community-driven R&D platform for the application of predictive models to advance learning analytics as well as institutional analytics capabilities.

In some cases, the workflow for some embodiments may include understanding the problem, reaching a diagnosis, prescribing a course of treatment for identified patterns, and tracking the success of the treatment. For example, upon logging in to the system, an advisor (one possible user role) may be presented with a pictorial list of his or her students (e.g. visual display 120 shown in FIG. 5). Associated with each student is a risk indicator: green indicates not at-risk, yellow indicates possibly at-risk, and red means at-risk. The advisor can click on a particular student or view the screen showing the list of students in a particular category (e.g. high risk).

Next, associated with each student is his or her Student Profile Screen (e.g. visual display 140 shown in FIG. 6). The Student Profile Screen provides an overview of the student's profile, including projected risk at both the course and institution level. The screen may also serve as a gateway to other screens, including Course Screens (e.g. visual display 150 on FIG. 7), which provide views into course-level activity and risks. The Notes Screen (e.g. visual display 230 on FIG. 10) provides case notes associated with the student while Referral Screen provides all the relevant referral options available at the institution.

The success (or failure) of the students are predicted using a prediction ensemble which combines prediction values from a plurality of hypothesis to obtain a combined performance prediction value indicative of how the student is expected to perform. By basing upon a number of factors, the prediction ensemble enables the selection of a whole collection, or ensemble, of hypotheses from the hypothesis space, and combines their predictions appropriately. One reason for using the prediction ensemble is that various indicators of learning success and risks can be found by analysing different aspects of the learning and teaching processes, the educational tools and instructional design, the pre-requisite competencies, the dynamics of a particular course, program or institution, as well as the modality of learning being fully online, live, or hybrid. Blending of multiple models to effectively express and manage complex and diverse patterns of the eLearning process may enable an instructor or an advisor to discover issues with the learners and develop insights.

Furthermore, the ensemble methods may boost the predictive generalizability by blending the predictions of multiple models. For example, stacking, also referred to as blending, is a technique in which the predictions of a collection of base models are given to a second-level predictive modelling algorithm, also referred to as a meta-model. The second-level algorithm is trained to combine the input predictions optimally into a final or secondary set of predictions.

Classifier ensembles allow solutions that would be difficult (if not impossible) to reach with only a single model. Stacking, data fusion, adaptive boosting, and related ensemble techniques have successfully been applied in many fields to boost prediction accuracy beyond the level obtained by any single model.

The embodiments described herein may implement some aspects of data fusion to build base models for different learning domains. Furthermore, the system uses a stacked generalization strategy. A best-fit meta-model takes as input predictors the output of the base models and optimally combine them into an aggregated predictor, referred to as a success indicator/index. In this type of stacked generalization, optimization is typically achieve by applying EM (Expectation Maximization) algorithm.

In some embodiments, the performance prediction module 52 described herein above may implement a data fusion model. The data fusion models may be useful for building individual predictive models that are well suited for subdomains of an application. These models correspond to each data-tracking domain and represent different aspects of the learning process. That is, each model may be designed for a particular domain of learning behaviour. An initial set of domains may be defined as: Attendance, Completion, Participation, and Social Learning.

For example, with regards to the Attendance domain, learner tracking data reflecting online attendance may be collected (e.g. by the monitoring module 50). The data may include number of course visits, total time spent, average time spent per session, in addition to other administrative aspects of the eLearning activities such as number of visits to the grade tool, number of visits to the calendar/schedule tool, number of news items/announcements read. A simple logistic regression model, or a generalized additive model, is suitable for this domain.

On the other hand, in the case of the social learning domain, social network analysis (“SNA”) techniques should be applied. SNA, in conjunction with text mining on learners discourse, may be implemented to extract meaningful risk factors and success indicators. In other words, the logistic regression model described above for the attendance domain may be considered insufficient for meaningful predictive analysis of the social learning domain.

In some cases, the predictive models for each domain are built independently as shown in FIG. 4. Each model generate an abstracted success sub-indicator (performance prediction value) represented as a predicted class and an associated probability estimate (ŷ, p̂), where p̂=p(Y=ŷ|X), and X denotes various domain-related activities being tracked.

One aspect of ensemble systems is the combining process for the prediction values generated by various models (e.g. models 100, 104, 110, 114, 115). Combination strategies for ensemble systems may be characterized along two dimensions: (1) trainable versus non-trainable rules, and (2) applicability to class labels versus class-specific probabilities.

By selecting a trainable rule, the blending weights associated with the prediction of individual models are optimized to obtain a best-fit meta-model. By selecting a non-trainable combination rule, the user is able to adjust the weight of the base predictions. For example, in a hybrid course where emphasis on discussion and social learning are primarily conducted face-to-face, the instructor can choose to dampen the effect of the social learning model from the overall prediction. The proposed ensemble system takes advantage of the estimated probabilities in combining the base predictions. In some embodiments (e.g. embodiments shown in FIG. 5), there are three risk-levels, and each base model generates as output a vector of three probability values corresponding to estimated probability for each of the levels “At-Risk”, “Potential Risk”, “Success”.

Let {g1, g2, . . . , gL} denote the learned prediction functions of L predictive models with gᵢ: Xⁱ→(Y, p ε|[0, 1]^{c}), ∀i, where Y are the risk categories, p is the associated probability vector, and c is the number of risk categories, i.e. c=3. For example, there could be four models such that L=4 corresponding to each of the data-tracking domains, at the course grouping/template level. The meta-model takes as input a matrix G with c=3 columns represent the risk categories and L=4 predictive models, where gᵢⱼ represents the probability of risk-level j according to predictive model gᵢ. It also takes as input the corresponding true outcomes y in the training dataset.

A simple non-trainable combining process would be to average the values gᵢⱼ for each column of G. Normalization to add to 1 over all categories may be applied. Then, the maximum likelihood principle is applied by selecting the risk category with maximum posterior probability as the aggregated success indicator. Alternatively, the outputs of the base models are used as input to find the best-fit second-level mapping between the ensemble outputs and the correct outcome (risk level) as given in the training dataset.

To find the best-fit meta-model, an iterative k-fold cross validation process may be applied. The training dataset is divided into k=L blocks and each of the first level model is first trained on L−1 blocks, leaving one block for the second-level model, at each iteration through the L blocks. The process is designed to achieve a reliable model fitting.

Linear regression stacking seeks a blended prediction function b represented as b(x)=Σᵢwᵢgᵢ(x), ∀xεX, where one advantage of this linear model is that it lends itself naturally to interpretation. Furthermore, the computational cost involved in fitting such a model is modest.

In this type of stacked generalization, optimization is typically achieved by applying EM (Expectation Maximization) algorithms. Big data arising from learner-produced data trails, ubiquitous learning, and networks of social interactions is giving rise to the new research area of learning analytics. These diverse and abundant sources of learner data are not sufficiently analysed via a single best-fit predictive model, as in the course signals system. Instead, the discovery and blending of multiple models to effectively express and manage complex and diverse patterns of the eLearning process is required.

The idea is that data from each learning modality, context, or level of aggregation across the institution, can be used to train base predictive models, whose output can then be combined to form an overall success or risk-level prediction. Applications in which data from different sources with different input variables are combined to make a more informed decision are generally referred to as data fusion applications.

Hence, the data fusion model may be useful for building individual predictive models that are well suited for sub-domains of an application. These models correspond to each data tracking domain and represent different aspects of the learning process. That is, each model is designed for a particular domain of learning behaviour.

The embodiments described herein, which may be referred to as the “Student Success System” (S3) may be provided as one tool that can be used in a learning environment.

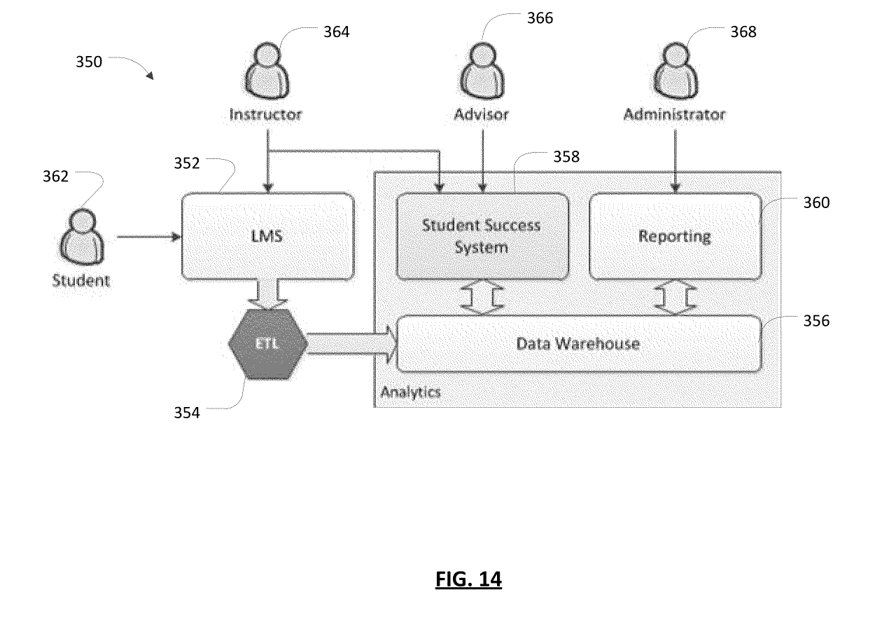

Referring now to FIG. 14, illustrated therein is a system 350 for providing a learning environment according to some embodiments. The system 350 includes a Learning Management System (“LMS”) 352, a Extract, Transform, and Load (“ETL”) Module 354, a data warehouse 356, a student success system 358 and a reporting module 360.

FIG. 14 also illustrates some exemplary operators who may interact with the system 350, namely, a student 362, instructor 364, advisor 366 and administrator 368. These operators are illustrated for explanation purposes and it should be understood that they do not form a part of the system 350.

The LMS 352, for example, could be a learning management system developed by Desire2Learn Inc. The data warehouse 356 may be an enterprise data warehouse that stores LMS data in a form suitable for reporting and analysis. The ETL module 354 executes extract, transform, and load processes for synchronizing data from the LMS to the data warehouse. The reporting module 360 generates a set of reports generated against the data warehouse.

The student success system 358 is a predictive sub-system that identifies at-risk students and offers insight into student progress. The student success system 358, for example, could include one or more components of system 10 and may implement one or more features as described above.

The students 362 interact with the LMS 352, leaving a trail of actions and artefacts, e.g. content access, discussions, grades. The instructors 364 interact with the LMS 352, provide content and assessment material, and manage their class. The instructors 364 also interact with the Student Success system 358 to gain insight into their students' progress and identify students who are at risk. The academic advisors 366 interact with the Student Success System 358 to identify students who need early intervention in order to promote student success. The administrators 368 interact mainly with the reporting component to generate reports that help them understand their institution's performance.

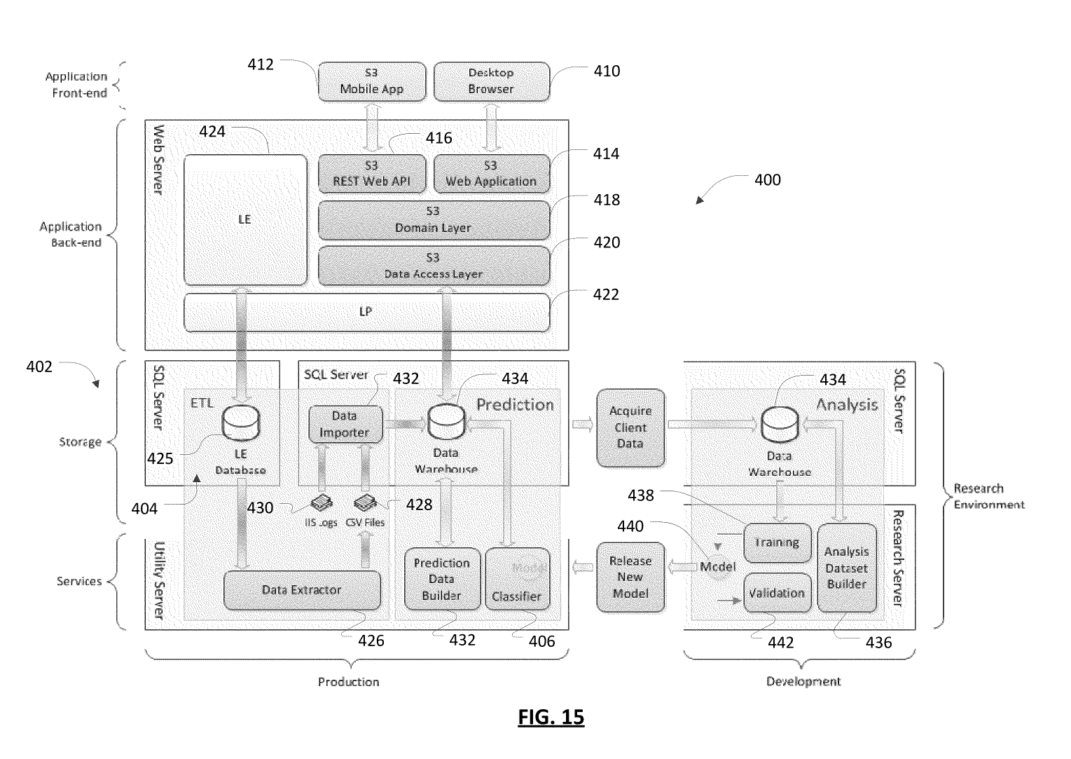

Referring now to FIG. 15, illustrated therein is a system architecture diagram for implementing a student success system (“S3”) application 400 according to some embodiments. The S3 application 400 involves multiple components that serve different purposes. FIG. 15 illustrates the various components, their dependencies and interactions, and the data flow between the components.

The S3 application in this example is a web-based application that has a typical layered architecture. In addition to providing access to desktop browsers, it also provides access to mobile devices through a Representational State Transfer (“REST”) based Application Programming Interface “API”, an exemplary design of outline of which is provided in Appendix “A”.

For storage, the S3 application 400 uses an Analytics data warehouse, for example as provided by Desire2Learn Inc., which is indicated by reference numeral 402. The S3 application 400 integrates with the rest of the Analytics architecture 402, which involves synchronizing data from the Learning Environment through an ETL process, as indicated by reference numeral 404. The S3 applicant adds predictive analysis of data in addition to reporting capability for Analytics data.

A classifier service 406 may be used to make predictions of student success based on live student data. The classifier service 406 relies on a predictive model that has been produced in development based on historical data. In order to produce this predictive model, a process by which historical data is acquired from clients may be employed. An analysis process is performed on the historical data, in which a training algorithm produces a predictive model capable of predicting student success. This model is validated against the historical data as well.

In some embodiments, the application front-end may be offered in two versions: a web browser version 410 and a mobile application 412 (e.g. native to iOS, Android or other mobile operating systems). The web browser version may be developed based upon the MVC web framework implemented by Desire2Learn Inc., including standard MVC controls. The mobile app may communicate with the S3 application 400 back-end through the S3 API.

The visualizations provided by the S3 application 400 will generally use the same mechanism for rendering charts on the client in both the web version as well as the mobile version. The client in both cases will host the chart on a web page (web view in case of mobile). Client-side JavaScript representation of the chart will be sent down from the server to the client, where the client will invoke a function to render the chart inside the web page/view.

The application back-end has a typical layered architecture. The front-end facing layer consists of two components: an MVC web application layer 414 for serving the desktop web version of the application, and the S3 API layer 416 for serving the mobile app. Both the MVC web application 414 and the S3 API 416 depend directly on S3 domain layer 418.

The domain layer 418 is where the domain entities and business logic lies. The domain layer 418 is also responsible for enforcing security through authorization rules. The domain layer 418 depends directly on S3 data access layer 420 for storage and retrieval of data. The domain layer 418 manages translation between data access layer 420 DTOs and domain entities.

The data access layer 420 is responsible for CRUD operations accessing the storage layer 402. This layer depends directly on LP data access framework 422, as well as stored procedures defined in the databases.

Caching of data objects using the distributed cache may be employed to reduce pressure on the database.

The predictions made by the S3 classifier relies on student data collected from the Learning Environment (“LE”) 424 and stored in a LE database 425. The LE data is synchronized to the Analytics data warehouse on a nightly basis through an ETL process 404.

A data extraction service 426 extracts relevant data from the LE database 425 and stores them into CSV files 428 in a predefined location on the file system. A data importer component 432 then imports the extracted data, along with IIS web logs 430, into the data warehouse.

Predictions are made based on a classification model that has been generated in development. A Prediction Data Builder service 432 builds the input data used for prediction by transforming existing data in the data warehouse into a format suitable for classification. The prediction data is stored back in the data warehouse 434.

The Classifier service 406 then goes through the prediction input data and produces the predictions. The classifier service uses a model that has been generated during development.

Analysis is done on historical data acquired from certain clients. An Analysis Dataset Builder component 436 builds the input data used for training and validation by transforming historical data in the data warehouse 434 into a format suitable for analysis. The analysis dataset is stored back in the data warehouse 434.

A Training component 438 then performs predictive modelling by learning the association of the input data to the actual output data. The output of the training component 438 is a predictive model 440. A Validation component 442 then validates the model by evaluating the accuracy of predictions made on test data. The purpose of the validation component 442 is to make sure that prediction accuracy is suitable for use in production.

Once the predictive model 440 is produced and validated, it is incorporated into the classifier component to be released in the next version of S3 application.

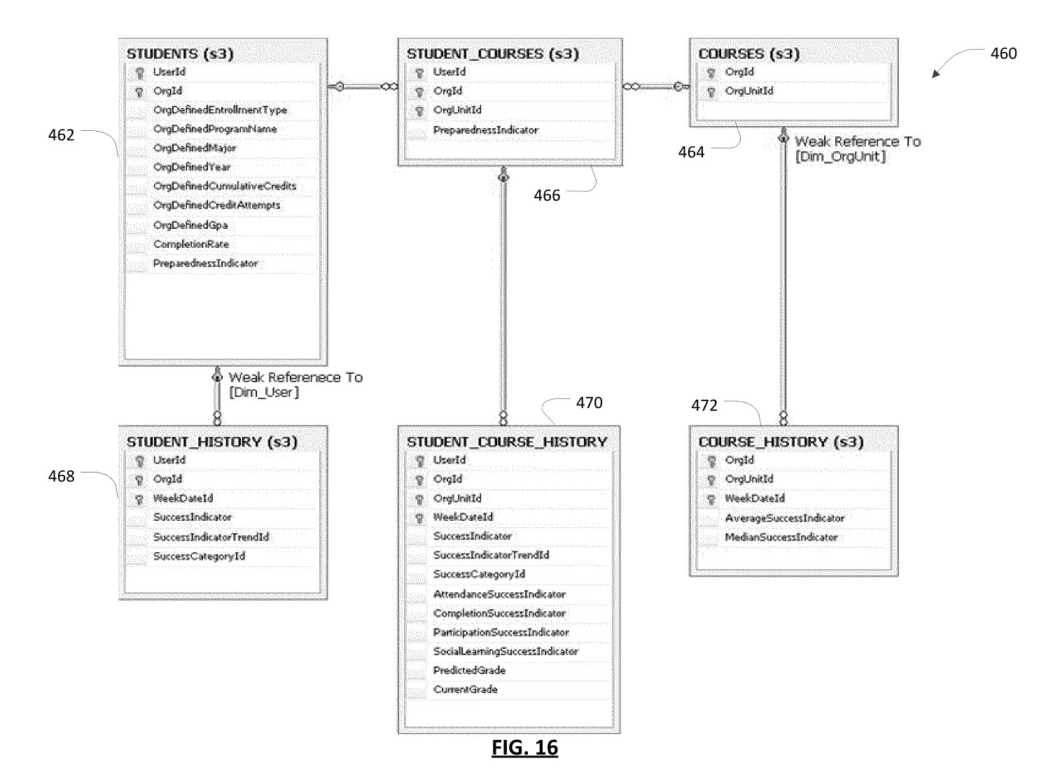

Referring now to FIG. 16, illustrated therein is an exemplary database schema 460 that may be implemented to store data related to the student success system.

Students data 462 represents students, including org-defined properties, as well as overall preparedness. Courses data 464 represents courses (no course properties are shown). Student Courses data 466: represents a student who is enrolled (or has been enrolled) in a course. Student History data 468 stores weekly historical values for student overall success indicator. Course History data 470 stores weekly historical values for course statistics. Student Course History data 472 stores weekly historical values for student course-specific success indicators.

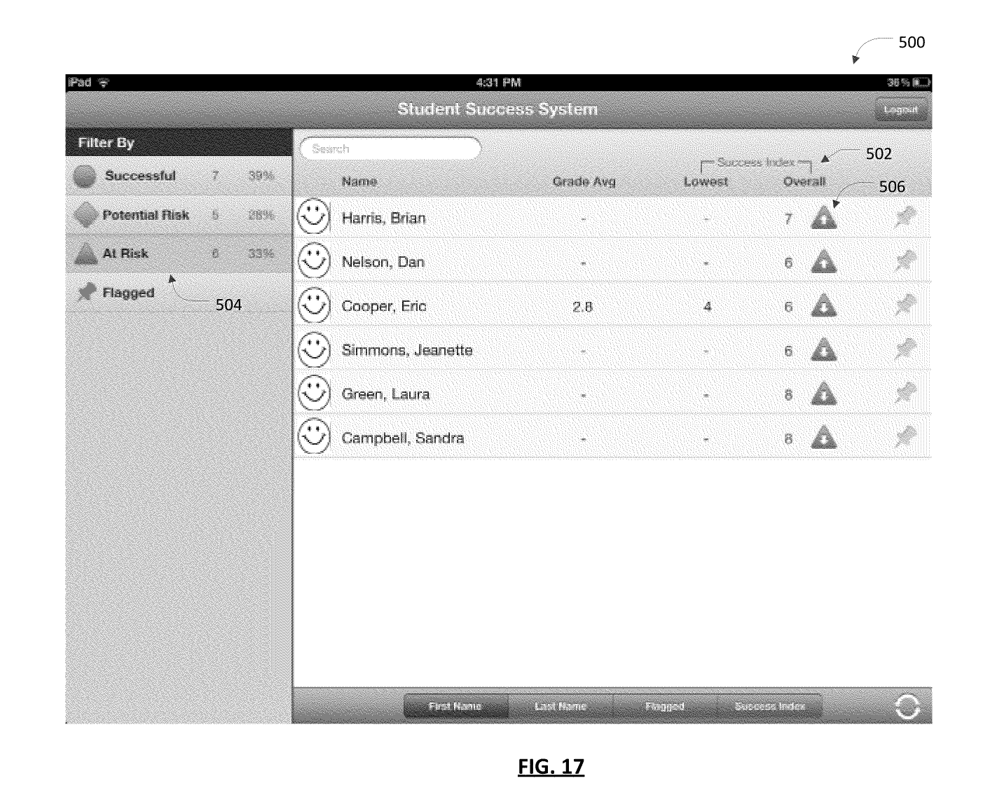

Referring now to FIG. 17, illustrated therein is an exemplary visualization 500 that may be provided according to some embodiments. The visualization 500 provides an overview of students in a class and their related “success index” 502. In the example, a filter 504 is applied such that only students who are at-risk are shown. The success index can be generated using performance prediction methods and systems described herein above. The indicators 506 associated with each student indicate whether the success index has decreased (as shown) or has improved (not shown). This allows a user viewing this screen to quickly determine whether the student is improving or worsening on the success index scale.

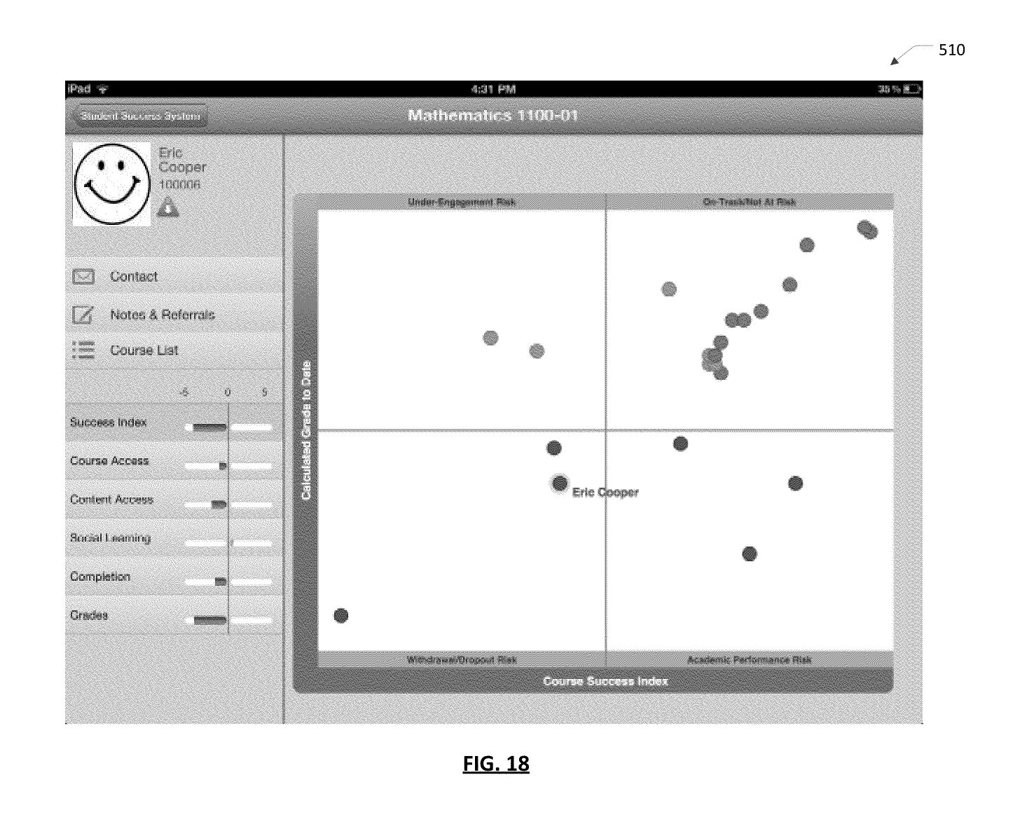

Referring now to FIG. 18, illustrated therein is an exemplary visualization 510 that may be provided according to some embodiments. The visualization 510 is similar to the visualization 200 shown in FIG. 9. The visualization 510, however, does not have layering options 201, which may provide a cleaner look.

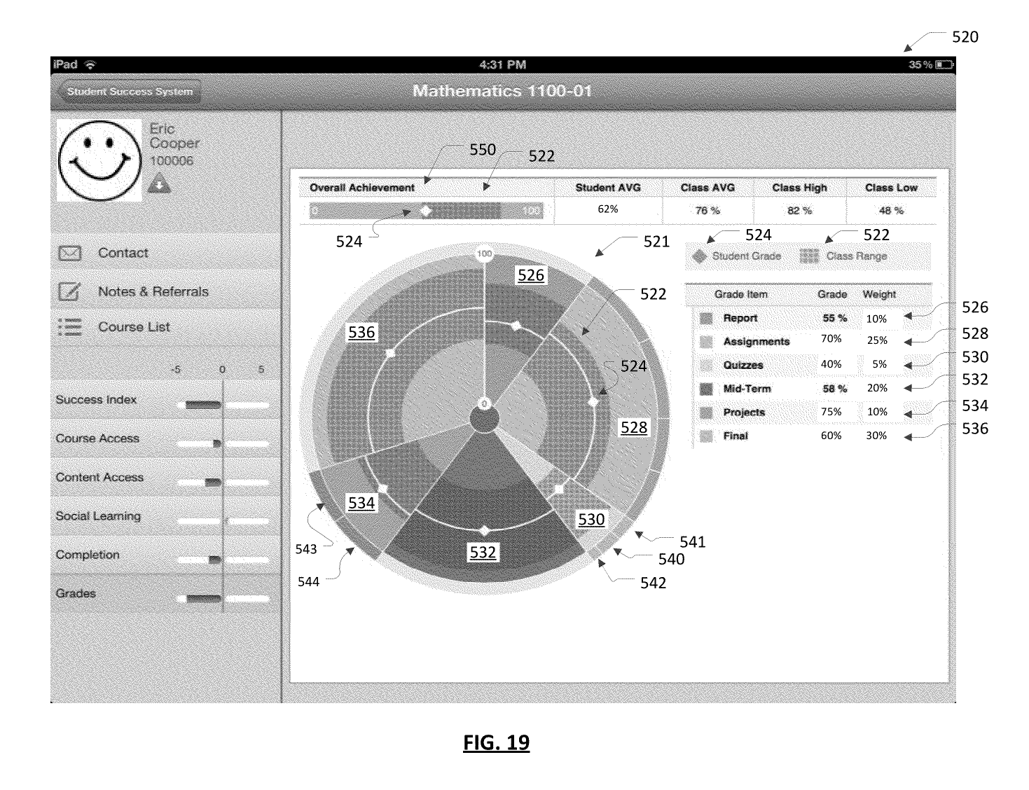

Referring now to FIG. 19, illustrated therein is an exemplary visualization 520 that may be provided according to some embodiments. The visualization 520 provides an overview of a student's achievement in a class relative to his peers.

As indicated in the legend provided, the student's grade is indicated by a diamond shaped indicator 524 while the class range is indicated by a shaded area indicated by reference numeral 522. The student's overall grade relative to his peers in the class is provided in the diagram 550. As shown, the student's overall grade 524 is on the lower end of the class range 522.

The visualization 520 also includes a pie-chart 521 that provides a break-down of how the student's overall grade is determined. As indicated in the provided legion, the overall grade is calculated from a combination of various graded activities throughout the course. The activities include a report 526 that is worth 10%, assignments 528 worth 25%, quizzes worth 5%, a midterm worth 20%, projects worth 10%, and a final examination worth 30%. Each of the activities is laid out as part of the pie-chart relative to the activity's weight, and each section of the pie-chart is indicated by the reference numeral associated with the activity. For example, the section 528 indicates the assignments 528, which are worth 25% and accordingly occupy a quarter of the pie chart. For each activity, the student's grade is indicated by reference numeral 524 which is overlaid on the class range indicated by reference numeral 522. For example, in section 528 for assignments, it can be observed from the visualization that the student's grade 524 is above the class average as it is located towards the outer edge of the pie chart on the class rage 522. Similar observations can be made for other sections of the pie chart related to other activities.

In some sections of the pie-chart, namely the sections 528, 530, and 534, the outer edge of the pie-chart is also sub divided. The number of sub-sections in the outer edge indicates the number of activities or times that made up the section. For example, for the section 530 associated with quizzes, the outer edge of the section is divided into three subsections 540, 541 and 542. This indicates that there were three quizzes administered. The size of the subsection relative to other subsection within the same section is indicative of the relative weight of each of the three quizzes. Similarly, the outer edge of subsection 534 associated with projects is divided into two subsections 543 and 544. This indicates that there were two projects. As the size of the subsections 543 and 544 are identical, the projects are weighted equally (i.e. 5% of the overall grade each).

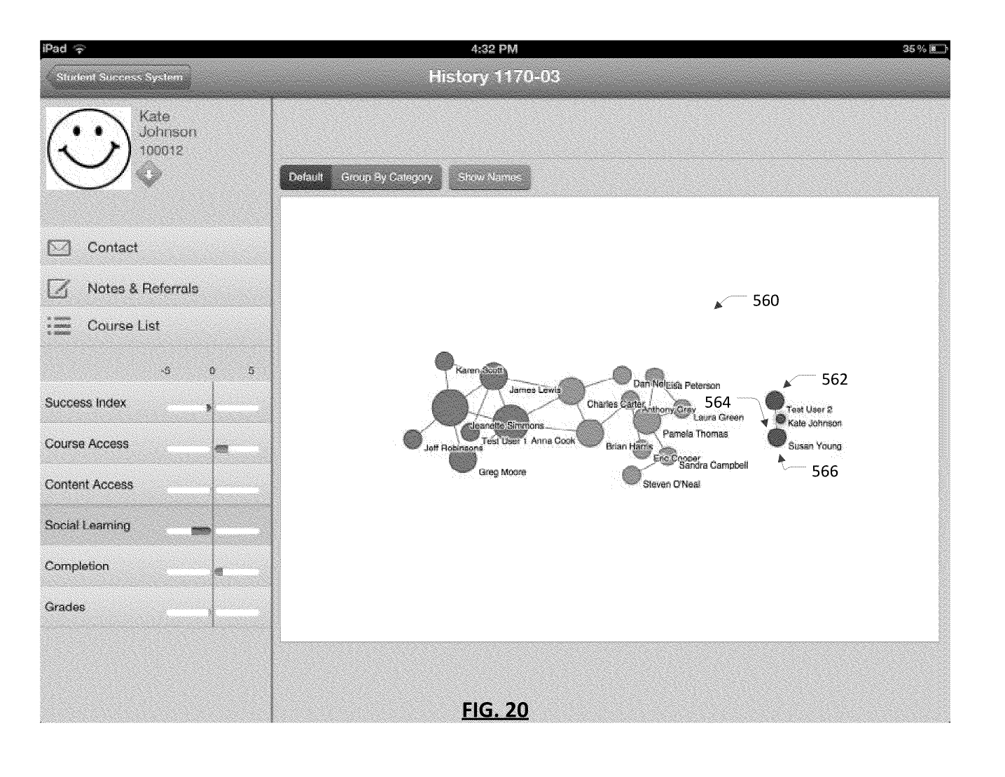

Referring now to FIG. 20, illustrated therein is an exemplary visualization 560 that may be provided according to some embodiments. The visualization 560 provides social-connectedness of the student in a class. Each of the nodes (for example nodes 562, 564, 566) represents a user in the class. The connections between the nodes represent communication between the users associated with the nodes (for example, email communications, forum or discussion group participation). The relative size of the nodes is indicative of how socially connected the user associated with the node is. For example, the node 564 associated with the current student has a relatively small area, which is indicative of the student's lack of social connectedness within the course. Each of the nodes may also be coloured (e.g. red, orange, or green) to provide an indication of the predicted success (or current grade) for the users associated with the nodes.

It should be understood that even though the embodiments are described herein in relation to electronic learning systems, they may be applicable in other fields of technology, such as health care.

While the above description provides examples of one or more apparatus, methods, or systems, it will be appreciated that other apparatus, methods, or systems may be within the scope of the present description as interpreted by one of skill in the art. Moreover, the scope of the claims appended hereto should not be limited by the embodiments set forth in the examples, but should be given the broadest interpretation consistent with the description as a whole.

APPENDIX A

```
S3 - API Design
The S3 exposes a REST API for consumption by the S3 mobile app
(or later by third-party clients). The REST API follows D2L general
extensibility patterns and guidelines, and will be subject to proper app-
level and user-level authentication. This document provides a conceptual-
level description of the API. The actual REST API reference will be made
available once the conceptual API is reviewed by the stakeholders.
The API is broken down into the following areas:
    Getting the Student List
    Getting a Student's Profile
    Getting a Student's List of Course Analytics Data
    Getting a Student's Course Analytics Data
    Getting a Student's Notes and Referral Data
    Adding a Note for a Student
    Making a Referral for a Student
Conceptual API Conventions
The following sections use the following convention to describe the
various API data elements and methods:
    Conceptual data element names are surrounded by by angle brackets,
    e.g. <Full Name>
    Arrays of data elements are surrounded by square brackets, e.g.
    [ <Student Basic Info> ]
    Methods are prefixed with “M:”
    Method parameters are prefixed with “P:”
    Method return Types are prefixed with “R:”
Getting the Student List
This API is used to get a list of students, including basic information about
each student.
The API supports the following capabilities:
    Restricting the list of students to those enrolled in a specific org unit
    Filtering the list of students by success index category
    Filtering the list of the students by name prefix (basic search feature)
    Sorting and paging of the list of students
Conceptual API
    M: GetStudentList
        P: orgUnitId: int (optional)
        P: successIndexCategory: <Success Index Category> (optional)
        P: namePrefix: string (optional)
        P: sortingInfo: [ <Sorting Info> ]
        P: pagingInfo: <Paging Info>
        R: [ <Student Basic Info> ]
Complex Parameter Types:
    <Success Index Category>: Enumeration { Successful, PotentialRisk,
    AtRisk }
    <Paging Info>
        <Page Number>: int
        <Page Size>: int
    <Sorting Info>
        <Field Name>: string
        <Is Ascending>: bool
Return Type:
    <Student Basic Info>
        <Full Name>: string
        <Picture URL>: string
        <Overall Success Index>: decimal
Note: The <Picture URL> is a secure URL that includes an access token
that allows the application to fetch the picture through a separate request.
Errors:
    Bad Request
    Not Authorized
    Org Unit Not Found (if orgUnitId parameter is specified)
Getting a Student's Profile
This API is used to get the profile and overall progress information of a
student. The API supports the following capabilities:
    Including or excluding the student overall progress information in the
    response.
Conceptual API
    M: GetStudentProfile
        P: userId: int
        P: includeProgressInfo: bool (optional)
        R: <Student Basic Info>, <Student Progress Info>
Complex Parameter Types:
None
Return Type:
    <Student Profile Info>
        <First Name>: string
        <Last Name>: string
        <ID>: string
        <Enrollment Type>: string
        <Faculty> or <School>: string
        <Major>: string
    <Student Progress Info>
        <College Preparedness>: decimal
        <College Success Index>: decimal
        <Cumulative Credits>: decimal
        <Completion Rate>: decimal
        <GPA>: decimal
Errors:
    Bad Request
    Not Authorized
    Student Not Found
Getting a Student's List of Course Analytics Data
This API is used to get a list of courses in which the student is currently
enrolled, along with the student's high-level analytics data for each
course.
The API supports the following capabilities:
    Including or excluding course analytics information in the response.
Conceptual API
    M: GetStudentCourses
        P: userId: int
        P: orgUnitId: int (optional)
        P: includeAnalyticsInfo: bool (optional)
        R: [ <Student Course Info> ]
Complex Parameter Types:
None
Return Type:
    <Student Course Info>
        <Course OrgUnitId>: int
        <Course Code>: string
        <Course Success Index>: decimal
        <Course Preparedness>: decimal
        [<Weekly Analytics Info> ]
            <Week Index>: int
            <Student Success Index>: decimal
            <Median Success Index>: decimal
Errors:
    Bad Request
    Not Authorized
    Student Not Found
    Org Unit Not Found (if orgUnitId parameter is specified)
    Analytics Info Not Available
Getting a Student's Course Analytics Data
Getting a Student's Notes and Referral Data
Adding a Note for a Student
Making a Referral for a Student
```

1. A computer-implemented method for predicting performance of at least one learner, the method comprising:
(a) for each learner having a user identifier associated therewith:
(i) defining a predictive model based upon a plurality of hypothesises for predicting learner performance, each hypothesis predicting learner performance based upon at least one learner engagement activity;
(ii) monitoring a plurality of the learner engagement activities associated with the user identifier for that user to obtain learner engagement values for each of the learner engagement activities;
(iii) generating at least one performance prediction value for each hypothesis based upon the learner engagement values associated with the hypothesis; and
(iv) combining the performance prediction values for the plurality of the hypothesises to generate a combined performance prediction value for the learner.

2. The method of claim 1, wherein determining the at least one prediction value for each hypothesis comprises:
(i) obtaining historical values for the plurality of learner engagement activities and corresponding historical performance data associated with one or more learners who had previously completed the learner engagement activities; and
(ii) for each of the learner engagement activities, comparing learner engagement values for that activity with the historical values and the corresponding historical performance data for that activity to generate the at least one performance prediction value for that activity.

3. The method of claim 1, wherein the plurality of hypothesises comprises predicting learner performance based upon social connectedness of the learner and the method includes monitoring social connectedness activities to obtain social connectedness values for that learner.

4. The method of claim 1, wherein the plurality of hypothesises comprises predicting learner performance based upon learner attendance and the method includes monitoring attendance related activities to obtain learner attendance values for that learner.

5. The method of claim 1, wherein the plurality of hypothesises comprises predicting learner performance based upon engagement of the learner and the method includes monitoring participation related activities to obtain learner participation values for that learner.

6. The method of claim 1, wherein the plurality of hypothesises comprises predicting learner performance based upon completion of the tasks provided to the learner and the method includes monitoring learner task completion activities to obtain learner task completion values for that learner.

7. The method of claim 1, wherein the plurality of hypothesises comprises predicting learner performance and the method further comprises generating learner preparedness values for that selected learner based upon performance of that selected learner in one or more other courses related to the course that learner is in, generating the at least one performance prediction value based upon the learner preparedness values, and combining the at least one performance prediction value with the other prediction values to generate the combined performance prediction value.

8. (canceled)

9. (canceled)

10. (canceled)

11. (canceled)

12. The method of claim 1, further comprising generating at least one visual display illustrating the learner engagement values and the combined performance prediction value for that selected learner relative to the historical learner engagement values and corresponding historical performance data.

13. The method of claim 1, further comprising generating at least one visual display illustrating performance prediction values for the learner engagement activities associated with at least one of the plurality of hypothesis relative to the combined performance prediction value.

14. (canceled)

15. (canceled)

16. (canceled)

17. (canceled)

18. (canceled)

19. (canceled)

20. The method of claim 1, further comprising providing suggested interventions based upon case-based reasoning for learners who have at least one performance prediction value that indicative of poor learner performance.

21. A performance prediction system comprising at least one processor, the at least one processor configured to:
(a) define a predictive model based upon a plurality of hypothesises for predicting learner performance, each hypothesis predicting learner performance based upon at least one learner engagement activity;
(b) monitor a plurality of the learner engagement activities associated with the user identifier for that user to obtain learner engagement values for each of the learner engagement activities;
(c) generate at least one performance prediction value for each hypothesis based upon the learner engagement values associated with the hypothesis; and
(d) combine the performance prediction values for the plurality of the hypothesises to generate a combined performance prediction value for that learner.

22. The system of claim 21, wherein the processor is configured to determine the at least one prediction value for each hypothesis by:
(a) obtaining historical values for the plurality of learner engagement activities and corresponding historical performance data associated with one or more learners who had previously completed the learner engagement activities; and
(b) for each of the learner engagement activities, comparing learner engagement values for that activity with the historical values and the corresponding historical performance data for that activity to generate the at least one performance prediction value for that activity.

23. The system of claim 21, wherein the plurality of hypothesises comprises predicting learner performance based upon social connectedness of the learner and the at least one processor is configured to monitor social connectedness activities to obtain social connectedness values for that learner.

24. The system of claim 21, wherein the plurality of hypothesises comprises predicting learner performance based upon learner attendance and the at least one processor is configured to monitor attendance related activities to obtain learner attendance values for that learner.

25. The system of claim 21, wherein the plurality of hypothesises comprises predicting learner performance based upon engagement of the learner and the at least one processor is configured to monitor participation related activities to obtain learner participation values for that learner.

26. The system of claim 21, wherein the plurality of hypothesises comprises predicting learner performance based upon completion of the tasks provided to the learner and the at least one processor is configured to monitor learner task completion activities to obtain learner task completion values for that learner.

27. The system of claim 21, wherein the plurality of hypothesises comprises predicting learner performance and the at least one processor is further configured to generate learner preparedness values for that selected learner based upon performance of that selected learner in one or more other courses related to the course that learner is in, generating the at least one performance prediction value based upon the learner preparedness values, and combining the at least one performance prediction value with the other prediction values to generate the combined performance prediction value.

28. (canceled)

29. (canceled)

30. (canceled)

31. (canceled)

32. The system of claim 21, wherein the at least one processor is further configured generate at least one visual display illustrating the learner engagement values and the combined performance prediction value for that selected learner relative to the historical learner engagement values and corresponding historical performance data.

33. The system of claim 21, wherein the at least one processor is further configured to generate at least one visual display illustrating performance prediction values for the learner engagement activities associated with at least one of the plurality of hypothesis relative to the combined performance prediction value.

34. (canceled)

35. (canceled)

36. (canceled)

37. (canceled)

38. (canceled)

39. (canceled)

40. (canceled)

41. A performance prediction system comprising at least one processor, the at least one processor configured to:
(a) define a predictive model based upon a plurality of hypothesises for predicting learner performance, each hypothesis predicting learner performance based upon at least one learner engagement activity;
(b) monitor a plurality of the learner engagement activities associated with the user identifier for that user to obtain learner engagement values for each of the learner engagement activities;
(c) generate at least one performance prediction value for each hypothesis based upon the learner engagement values associated with the hypothesis; and
(d) combine the performance prediction values for the plurality of the hypothesises to generate a combined performance prediction value for that learner;
(e) wherein the processor is configured to determine the at least one prediction value for each hypothesis by:
(i) obtaining historical values for the plurality of learner engagement activities and corresponding historical performance data associated with one or more learners who had previously completed the learner engagement activities; and
(ii) for each of the learner engagement activities, comparing learner engagement values for that activity with the historical values and the corresponding historical performance data for that activity to generate the at least one performance prediction value for that activity;
(f) wherein:
(i) the at least one learner is associated with a course in an electronic learning system,
(ii) the learner engagement activities are associated with a plurality of resources offered in the course,
(iii) historical values for the learner engagement activities and the corresponding performance data are associated with one or more learners who had previously completed one or more selected courses and
(iv) the combined performance prediction value is indicative of the predicted performance of the at least one learner in the course.
